(19) United States
(12) Patent Application Publication
(10) Pub. No.: US 2026/0127700 A1
(43) Pub. Date: May 7, 2026

(54) SYSTEMS, METHODS, AND APPLICATIONS OF IMPERFECT PATTERNS FOR DATA ENCODING

(71) Applicant: Spot Vision LLC, Oak Grove, OR (US)

(72) Inventors: Joshua Victor ALLER, Oak Grove, OR (US); Nicholas RIEHL, Portland, OR (US)

(73) Assignee: Spot Vision LLC, Oak Grove, OR (US)

(21) Appl. No.: 19/435,351

(22) Filed: Dec. 29, 2025

Related U.S. Application Data
(63) Continuation-in-part of application No. 19/386,102, filed on Nov. 11, 2025.
Application No. 19/386,102 is a continuation of application No. 18/684,013.
(60) Provisional application No. 63/234,905, filed on Aug. 19, 2021.
(60) Provisional application No. 63/348,561, filed on Jun. 3, 2022.
(60) Provisional application No. 63/740,230, filed on Dec. 30, 2024.

(51) Int. Cl. G06T 1/00

(52) U.S. Cl. CPC G06T 1/0028; G06T 1/0064; G06T 2201/0051

(57) ABSTRACT

Systems, methods, and articles are disclosed for encoding data using imperfect patterns formed from graphic elements arranged on a surface. A data record is encoded through controlled variations in the graphic elements relative to a common layout such that the data record is redundantly represented and recoverable from observation of a portion of the pattern. Images of the pattern may be processed to extract and verify the data record under viewing conditions including partial occlusion, distortion, or noise. In some embodiments, decoding outputs include confidence or consistency assessments, identification of image regions contributing to decoding, or visual augmentation to guide user interaction. The techniques support robust machine-readable encoding while preserving aesthetic flexibility for applications including authentication, inventory tracking, and user interfaces. Other embodiments may be disclosed and/or claimed.

### CONTINUITY AND CLAIM OF PRIORITY

This application claims priority to U.S. Provisional Application 63/740,230, filed on Dec. 30, 2024, titled “Systems, Methods, and Applications of Imperfect Patterns for Data Encoding.”, which is incorporated by reference herein.

This application is also a continuation-in-part of U.S. patent application Ser. No. 19/386,102, filed on Nov. 11, 2025, titled “Use of Imperfect Patterns to Encode Data on Surfaces”, which is a continuation of U.S. patent application Ser. No. 18/684,013, filed on Feb. 15, 2024, titled “Use of Imperfect Patterns to Encode Data on Surfaces”, which is a U.S. national phase entry of International Application No. PCT/US2022/038291 (WO 2023/022858), filed on Jul. 26, 2022, titled “Use of imperfect patterns to encode data on surfaces”, which claims priority to both U.S. Provisional Patent Application No. 63/234,905 titled, “DATA ENCODING CELLULAR MARK PATTERNS”, filed Aug. 19, 2021, and U.S. Provisional Patent Application No. 63/348,561, titled “METHOD AND APPARATUS FOR DATA ENCODING PATTERNS”, filed on Jun. 3, 2022, all of which are incorporated by reference herein.

### FIELD

Various embodiments relate to machine-readable optical codes. More specifically, the various embodiments relate to generating machine-readable optical codes, encoding information into optical codes, inscribing objects with the optical codes, and reliably reading the codes from images of objects decorated with the codes.

### BACKGROUND

This disclosure provides clarifications, improvements, enhancements, expansions, and new areas of application for the imperfect patterns described in U.S. patent application Ser. No. 18/684,013. The prior application introduced methods for encoding data using imperfect patterns that provide robust and reliable data decoding as well as a means of communicating a predefined aesthetic. However, certain limitations existed for some embodiments, such as the lack of dynamic selection of decoders for specific patterns, limited robustness to visual distortions, and insufficient adaptability to new functional areas. This disclosure builds upon that foundation by addressing specific limitations, improving the versatility of the patterns, and expanding their functional use cases across additional fields.

### SUMMARY

This disclosure builds upon the methods for encoding data using imperfect patterns described in U.S. patent application Ser. No. 18/684,013. In particular, this disclosure provides clarifications, enhancements, and expansions to the previously disclosed methods, improving the versatility and functional applications of the imperfect patterns. Various embodiments introduce additional processes for generating, transforming, and decoding imperfect patterns, including the creation of encoder-decoder pairs, selection of appropriate decoders for specific patterns, and ensuring robustness to visual distortions and environmental conditions. These improvements address limitations in prior methods and extend the use of imperfect patterns to new areas of application, such as advanced data encoding, authentication systems, user-interactive applications, and enhanced aesthetic integration.

By incorporating these enhancements, some of the various embodiments may provide more reliable and efficient pattern generation, decoding, and application across diverse fields, while maintaining the ability to communicate predefined aesthetics. The improvements ensure robust performance under real-world conditions, enhance system usability, and expand the practical utility of imperfect patterns in fields such as security, retail, supply chain management, branding, and interactive technologies.

### BRIEF DESCRIPTION OF THE DRAWINGS

FIG. 1 depicts a system to create and manage sets of articles marked with imperfect patterns.

FIG. 2 depicts a method to develop a dual function imperfect pattern.

FIG. 3 depicts example additional outputs of a decoder.

FIG. 4 depicts additional loss components for training.

FIG. 5 depicts an example process to interpret decoder outputs.

FIGS. 6A-6E depict processes to crop and scale images of imperfect patterns.

FIG. 7 depicts use of alternate pre-processing modules for decoding.

FIG. 8 depicts a method of recovering imperfect patterns from different processed images.

FIG. 9 depicts a modified decoder process detecting patterns from different templates.

FIG. 10 depicts an imperfect pattern comprising marks in a transformation hierarchy.

FIGS. 11A and 11B depict testing an image for support of a data record.

FIG. 12 depicts a support query module.

FIGS. 13A-13C depict decoding multiple imperfect patterns in an image.

FIG. 14 depicts visual feedback on patterns of 3D objects.

### DETAILED DESCRIPTION

U.S. patent application Ser. No. 18/684,013 is incorporated by reference herein, and will hereinafter be referred to as the '013 application. The following detailed description describes illustrative embodiments of systems, methods, articles, and applications involving imperfect patterns for data encoding and decoding. These embodiments are provided to enable a person of ordinary skill in the art to make and use the disclosed subject matter and are not intended to limit the scope of the invention, which is defined solely by the appended claims. Numerous specific details are set forth to provide a thorough understanding of the disclosed embodiments; however, it will be apparent that the disclosed subject matter may be practiced without these specific details.

The embodiments described herein build upon and extend the imperfect pattern techniques disclosed in U.S. patent application Ser. No. 18/684,013. Where appropriate, the present disclosure clarifies, refines, or expands upon the systems and methods of the '013 application, including the generation of imperfect patterns, training of encoder-decoder pairs, decoding under real-world conditions, and new functional applications enabled by these techniques.

In the following sections, reference is made to the accompanying drawings, which form a part of this disclosure. The drawings illustrate specific example embodiments in which the disclosed techniques may be practiced. Like reference numerals refer to like elements throughout the drawings. The embodiments illustrated in the drawings and described herein are not intended to be exhaustive or limiting. Rather, they are provided to illustrate representative implementations and to demonstrate how various features may be combined or adapted in different applications.

Unless otherwise indicated, functional blocks shown in the figures may be implemented using hardware, software, firmware, or combinations thereof. Processing steps described as being performed by modules, components, or systems may be performed by one or more processors executing stored instructions, by dedicated circuitry, or by distributed computing resources. Features described in connection with one embodiment may be combined with features of other embodiments in any suitable manner.

The detailed description proceeds by first describing core system architectures and pattern generation processes, followed by embodiments addressing decoding robustness, confidence assessment, support queries, visual feedback, and multi-object scanning. Additional sections describe adaptations for aesthetics, security, authentication, retail environments, apparel, camouflage, and user interface optimization. Collectively, these embodiments demonstrate the flexibility and breadth of the disclosed imperfect pattern techniques across a wide range of practical applications.

### Core Concepts and System Design

We review the core concepts disclosed in the '013 application and illustrate a number of system goals and designs.

### System Configurations

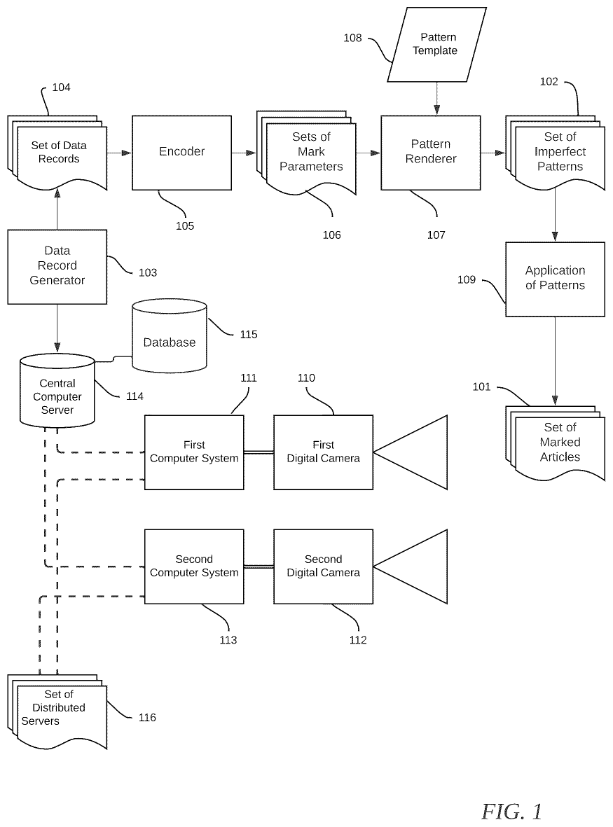

Numerous locations of the '013 application (including paragraphs [0055], and [0075]-thereof) disclose examples of sets of articles (hoodies, boxes, products, camouflaged articles), with each article of the set displaying an imperfect pattern that identifies the specific article. FIG. 1 illustrates the creation and processing of sets of articles as should be understood from the '013 application by combination of the numerous examples therein.

A set of marked articles 101 such as those from the prior examples, is configured such that each article of the set displays an imperfect pattern that provides a visually consistent design within the set while supporting functional identification across the set. The design may yield measurable functional outcomes, such as aligning with a predefined aesthetic, fostering brand recognition, influencing consumer behavior, streamlining user interface operations, or establishing trust. Each imperfect pattern in the set of imperfect patterns 102 differs slightly from the others, with marks altered in placement or configuration to encode a distinct data record that uniquely identifies each article.

The set of marked articles 101 may be constructed by first generating 103 a set of distinct data records 104. The data records are each processed by an encoder 105 to produce sets of mark parameters 106. The sets of mark parameters could, for example, be represented by a two dimensional array with a first dimension corresponding to the article and a second dimension corresponding to the mark parameter.

A pattern renderer 107 combines the sets of mark parameters 106 with a pattern template 108 to generate the set of imperfect patterns 102. These imperfect patterns may then be applied 109, to the corresponding set of articles through methods such as article manufacture, direct printing on the article, or application to a label or sticker affixed to the article, resulting in the production of the set of marked articles 101.

The set of marked articles 101 may be utilized by a system comprising multiple cameras and computers, as represented in FIG. 1 of the present application by a first digital camera 110 connected to a first computer system 111 and a second digital camera 112 connected to a second computer system 113. The first digital camera 110 and second digital camera 112 may be located at separate locations. For example, cameras may be positioned at points of manufacture, shipping, distribution, point-of-sale, or disposal to track the product throughout its entire lifecycle.

Alternatively, the cameras may be located at a single site and may provide the ability to scan one or more articles from multiple perspectives, or enable multiple workstations or point of sale terminals to simultaneously be scanning marked articles from the set 101.

Recall that the set of unique data records 104 may be generated 103 and used to identify the individual members of the set of marked articles 101. Such identifying portions of a data record may, for example, comprise a serial number, a universal identifier, or a unique hash value. In addition to being used by the encoder 105, the data records may also be sent to a central computer server 114, where they may be stored in or be used as a token to access or store information in a database 115.

The database may also store information associated with each article (as identified by its imperfect pattern or associated data record), for example, the article's last scanned location, its date of manufacture, source of components or ingredients, or product registration information. Alternatively the data records may be stored in a set of distributed servers 116, such as a cloud computing arrangement, or stored in a distributed database such as blockchain.

The first computer system 111 and the second computer system 113 may each process the images produced by the first digital camera 110 and second digital camera 112 respectively, running a decoder for the imperfect patterns using a processor to extract the data record associated with each marked article in their view. The first computer system 111 or second computer system 113 may then use the identifying data record as a key to access information stored in the database 115, which may be accessed by communicating with the central server 114.

Alternatively, the first computer system 111 or the second computer system 113 may optionally pre-process the image then transmit the image to the central computer server 114 or to the set of distributed servers 116 for decoding. A decoder, running on the central computer 114 or on distributed servers 116 such cloud computers, may decode the image, for example on hardware specifically optimized for inference of machine learning models, to produce the data record.

The data record may then be used internally by the central computer server 114 to perform an action, such as logging the location of the article, storing, retrieving or updating information associated with the article, or authenticating the article. Information, potentially including the identifying data record, or information associated with the article may then be transmitted back to the first computer system 110 or second computer system 113 that may trigger actions, such as displaying confirmation of successful scan, or utilizing or displaying information transmitted back from the central server 114 or the distributed servers 116.

### Imperfect Patterns as Ensembles

Recall from numerous locations of the '013 application (especially paragraphs [0015]-[0016] thereof) that an imperfect pattern comprises plurality of marks, and that the marks encode the data through their configuration or placement in the pattern, as controlled by mark parameters that are generated responsive to a specific data record encoded.

One could imagine that it would be possible to analyze an image and recover mark parameters, however, for many imperfect patterns this act may not be feasible. First, recall from numerous locations in the '013 application (especially paragraphs and thereof) that imperfect patterns may repeat across a surface and may contain no locating devices to register the marks against a fixed coordinate system. Thus making a correlation between an observed mark and a specific mark parameter may not be possible.

As an example, recall the imperfect pattern depicted in FIG. 16 of the '013 application which comprises a baby's head placed and rotated in each instance of a 3×3 grid. If this pattern is repeated across the surface of an object, and an image of a portion of the surface is analyzed, there are no guides to correlate an observed mark to the specific mark in the pattern template from which it was derived. Yes, such imperfect patterns are perfectly capable of being encoded and decoded.

Other types of marks, for instance marks used in the isocontour example of the '013 application (especially paragraphs [0260]-[0266] thereof) or the thresholded field marks described as part of the camouflage example of the '013 application (especially paragraphs [0269]-[0276] thereof) are generated based on the interaction between multiple mark parameters. By observing these types of marks it is not possible to measure the original mark parameters from an image of the imperfect pattern. Marks may also overlap, and may obscure each other, such that it is not always possible to see each mark in the pattern.

Clearly, mark parameters may not always be recovered from an image of an imperfect pattern. Yet in each of the preceding example cases, a decoder, as generated, for example, in numerous locations of the '013 application (especially paragraphs [0355]-[0371] thereof), is able to reproduce the data record encoded with the mark parameters even though mark parameters themselves are not derivable. Further, the decoder may reliably reproduce the data record from a broad range of viewing angles, with perspective distortion, and when the marks are visible on a singly or doubly curved surface, and with random mere portions of the pattern visible.

So, we may extract the data record used to generate the mark parameters, but may not be able to extract the mark parameters directly from the image. As an analogy, a data record may be considered a blueprint for a building, the mark parameters may be the construction techniques, materials and adjustments made by the builders, and the imperfect pattern may be the building. A person observing the building may be able to derive a blueprint for the building but can't fully reverse engineer the construction methods or material choices for creating it.

Because, in such instances, it is inconceivable that the decoder is internally extracting mark parameters to arrive at the data record, the decoder must be inferring the data record from the pieces of information the decoder can observe, which are the appearance of and the observed interaction (the relative relationships) between marks.

For example, while the absolute placement or orientation of the baby heads in the previous example may not be derivable, we are still able to observe the interaction between placed baby heads based on their relative placement and relative orientation of baby heads.

Recall also that a mark parameter is not correlated to a specific bit, but rather is derived from data record as a whole. As a result of the masked training process, information (the data bits) may be distributed across the mark parameters such that no single graphic element expressing is necessary. As an example, an arbitrary half of the graphic elements may be missing from a swatch of an imperfect pattern yet the swatch makes apparent the full data record when analyzed by the decoder.

The data record is an emergent property of the observed relative interactions between the marks, and the marks themselves work together as an ensemble that represents the full data record invariantly through many types of omissions and distortions.

### Combining Aesthetic and Functional Goals

Recall from paragraphs [xxxx] of the '013 application that imperfect patterns serve multiple functions, a function derived from their data carrying ability, and a function derived from the specific aesthetic. Both goals may be achieved because the same data record may be encoded into an innumerable number of imperfect patterns of various designs to serve different functional goals.

### Aesthetic Variety

The integration of graphic elements into imperfect patterns serves both functional and aesthetic purposes, allowing surfaces displaying the patterns to communicate encoded data while maintaining visual appeal.

These graphic elements may be derived from varied artistic sources, the article may enhance aesthetic variety, which may indirectly support technical functionality by improving user engagement, facilitating recognition of encoded information, streamlining user interactions, or guiding user focus on key elements. This combination of functionality and aesthetics may, in turn, enrich the user experience, support brand differentiation, and improve the article's overall effectiveness in achieving its intended purpose.

The graphic elements may be sourced from a range of artistic designs, each characterized by distinct color schemes, patterns, or visual motifs. This overall variety may contribute to a design that is visually engaging and distinguishable from existing designs, offering both functional and aesthetic benefits.

While the primary purpose of these graphic elements may be to encode and communicate data records, their varied origins and inherent visual differences may enhance user experience by improving engagement, aiding in recognition, and reinforcing the perceived quality and uniqueness of the article. Aesthetic variety and visual continuity across the article's surface may also support functional goals, such as fostering brand identity, guiding user focus, or simplifying interactions by creating a cohesive and appealing design.

For example, in one embodiment, a first graphic element derived from Artwork A may feature a geometric pattern, while a second graphic element sourced from Artwork B may showcase a floral motif. When these elements are positioned adjacently, their alignment across boundaries may maintain a cohesive design without visual interruption.

This aesthetic variety may offer measurable benefits, such as increased visual appeal, enhanced brand differentiation, and greater user engagement. Additionally, it may support customization and personalization, recognition, enabling the product to cater to a broader range of consumer preferences.

Although the graphic elements may contribute to the article's aesthetic variety, they remain tangible, functional features integral to its design. They do not invoke abstract ideas or natural phenomena but instead fall within the statutory category of manufacture, ensuring alignment with patentability requirements.

### Matching a Pre-Existing Aesthetic

There are a number of functions that are enabled by matching a pre-existing aesthetic. As one example, one may seek to perceptually hide data, by encoding data in a way that is visually indistinguishable from a pre-existing design while still being machine-detectable.

Alternatively, we may wish to help users identify information more naturally. For example, by using branding elements such as trademarks, or instructional markings such as text or arrows, an imperfect pattern may serve to instruct a user, and by using recognizable design, the instructions may be conveyed naturally while also conveying hidden data. As an example, the letters of the word “F-R-A-G-I-L-E” may be slightly altered in placement or other visible property to encode a data record.

We may need to include information for regulatory compliance, for example, icons indicating that a package contains flammable items, lithium ion batteries, or medical waste. Using these same required elements as part of a data encoding imperfect pattern allows for efficient dual-use of the surface.

There may also be functional reasons for using an existing design as the basis for an imperfect pattern. For example, we may need to ensure brand continuity across products that have traditionally displayed a recognizable graphic design.

Matching a pre-existing aesthetic may be accomplished, for example, by extracting all the graphic elements of a pre-existing design, and arranging the elements in corresponding imperfect patterns. Additionally, a user may specify how each element may vary and to what degree, in the imperfect pattern in order to encode data. An encoder-decoder pair may be generated, for example by the training processes described in embodiments of the '013 application, and the design may be tested. If the function of the design is not sufficient, one may employ techniques described in further sections to adapt the design for increased functionality.

### Dual-Use Patterns

Recall from various sections of the '013 application that imperfect patterns may perform more than one function simultaneously. For example, in paragraphs [0013], [0044], [0190] of the '013 application we describe how an imperfect pattern may encode data and convey an emotional framing or predefined aesthetic, in paragraph [0058] of the '013 application we describe how an imperfect pattern may encode data and be used as a form of camouflage to hide an object, and in paragraph [0076] of the '013 application we describe how an imperfect pattern may be used to encode data and identify a brand.

If we consider that marks may also comprise text, the marks, in addition to communicating data, could also serve human readable functions of identification, instructions, warning, or personalization.

While we have established each of these examples of dual function, it would be useful to examine each of these cases and others in more detail to understand how that function can be achieved.

### Aesthetic Functions of Imperfect Patterns

As described in paragraphs [0013], [0044] and [0190] of the '013 application, imperfect patterns are patterns that may communicate a prescribed emotional framing selected from an unlimited range of potential graphic designs.

Let's discuss how aesthetics performs a function for an article displaying an imperfect pattern, or for the organization employing the pattern as a human interface. As discussed in paragraphs [0003]-[0007] of the '013 application, an imperfect pattern may effectively communicate with humans at an emotional or cultural level in a way that influences the target human behavior and decision making.

Certainly, for many brands, it would be inconceivable to cover the entirety of a product package with a code that detracted from the predefined brand image. QR codes, for instance, littered across the surfaces of a product to make it scannable from any side would likely deteriorate the brand image in the customer's mind, or make the product look less attractive than a competitor's product whose brand or product impression is not deteriorated by the outside of brand image QR markers.

Products are typically wrapped in attractive, thematically correct graphic designs because those graphic designs are necessary to sell the product in a competitive retail environment. There are lots of ways that such a product preference could be measured, for instance, by consumer A/B testing, but measurement of eye contact with a product, by measurement of an end goal such as looking at, picking up, or purchasing the product compared to similar products packaged with different packaging designs.

Let's look at a process that we could use to optimize a packaging line design to achieve two goals: matching a predefined aesthetic, and encoding data in the design.

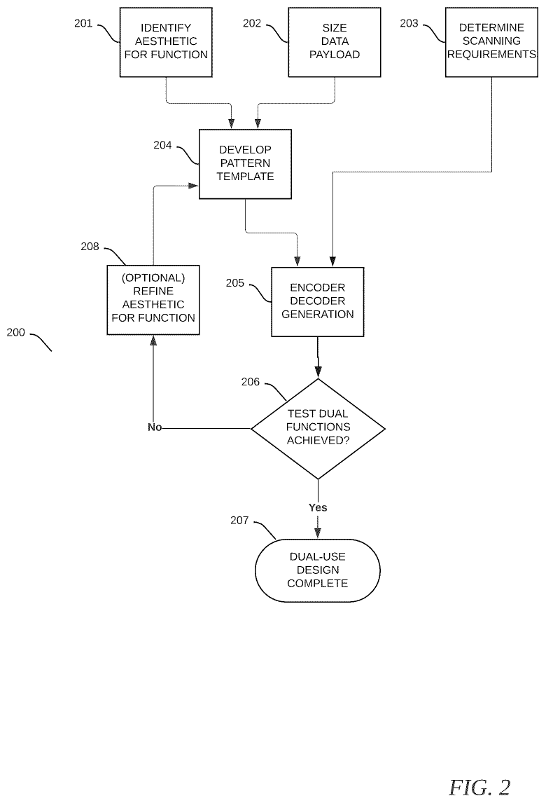

FIG. 2 of the present application illustrates one such process 200 that can be used to create an imperfect pattern matching a predefined aesthetic such as a brand image, driving a functional outcome such as increased engagement, usage, purchasing, or driving a higher level of a measurable metric such as visits, return visits, interactions, or customer satisfaction ratings.

As this process could apply to many functional goals, we will first use an example of creating a dual-purpose imperfect pattern that is consistent with a company's brand image.

First, we identify 201 the predefined aesthetic, potentially including: colors, typography, shapes, or imagery consistent with the functional goals and/or brand's identity. We could also identify an emotional framing we would like to use the pattern to communicate, such as luxury, eco-friendliness, comfort, or modernity. Such emotional framing will drive functional behavior we can later test.

We also size 202 the data payload to be encoded in the imperfect pattern, which may, for example, comprise a unique identifier, batch information, or authentication data. We determine the number of bits necessary to encode our desired payload, which may include a number of additional bits for use with an error detection or correction algorithm, and any bits assigned for future use.

Next we develop 203 a pattern template which acts like a blueprint for generating the pattern. It includes marks which may, for example, be any of the types of marks discussed throughout the '013 application including logos, curves, symbols consistent with the brand image. The marks are configured and laid out in a pattern space. The template may also use colors consistent with the brand image layer elements to achieve the desired emotional framing and branding needs. Also, the predefined transformations allowed for each mark, to allow for encoding of data, are specified in the pattern template along with the predefined limits of such transformations.

If the pattern is meant to be applied in a repeating fashion, elements may be placed across pattern repeat boundaries as described in numerous locations in the '013 application (especially paragraphs [0237]-[0244] thereof) in order to diminish the appearance of the seam, provide a more consistent mark density across the pattern (providing more uniform scanning performance), to facilitate alignment of sections of pattern during installation, or to align with a seamless predefined aesthetic of the brand.

In an authoring system that lays out the graphic elements for the pattern template, the designer may preview the transformations or seamless appearance of the pattern by generating sample imperfect patterns—not encoding data but simply choosing random mark parameters from within the prescribed range of transformations. To ensure that the look fits the predefined aesthetic or functional goals, and also to ensure that the marks have sufficient coverage of the pattern space to provide uniform

We also need to determine 204 the environmental envelope in which we want scanning to be successful. For example, the range of viewing angles, distances, surface shapes, and portion sizes, image contrast and noise levels we would like to be able to successfully scan this imperfect pattern.

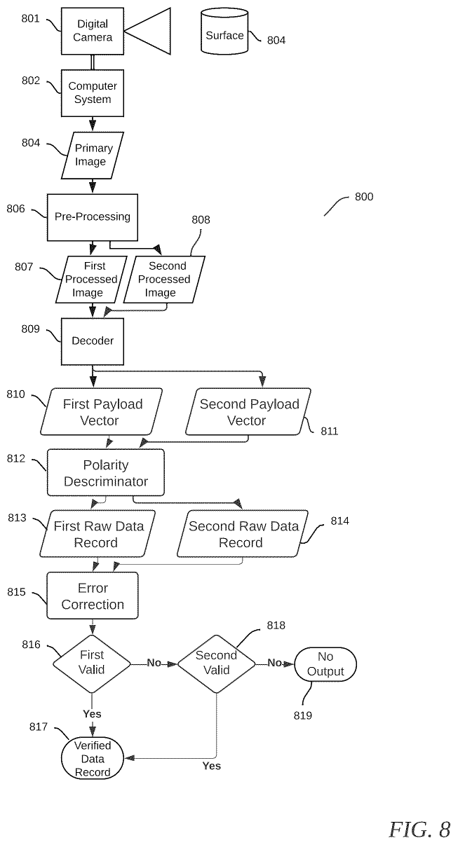

Next, we generate 205 an encoder and decoder, for example, by use of a training process such as the process 800 of FIG. 8 of the '013 application. The training process may continue until we reach a predetermined level of performance, for example until the accuracy of each bit in the data record exceeds a threshold value such as 98%, at which point we have achieved our scanning goal in a simulated environment, or when a determination is made, based on insufficient accuracy achieved in a certain time limit, for example, that the scanning function has not been achieved.

If we are successful in generating an encoder and decoder pair to the desired accuracy within the simulated environmental envelope, we continue to test 206 dual functions of the article.

As we have trained to a sufficient accuracy, we may wish to further test with real images of the imperfect pattern applied to real objects to validate that accuracy measured meets our scanning requirements. If it does not, and a domain gap exists, the envelope of the training environment may be adjusted to more closely match the characteristics of the validation images in order to minimize any difference in training or validation scanning performance.

If we have failed to achieve our scanning performance, we must update the pattern template to address the scanning performance issues. For example, we add more marks, make their transformations larger, or make the artwork more visible in order to achieve a higher scanning reliability.

In addition to meeting a predefined scanning performance, we also must meet a predefined outcome derived from the functional aesthetics of the pattern. In the case of identifying a brand, we could measure this in a number of ways. A simple way would be brand representative to sign-off on the design as being in line with the brand identity and image the company would like to project. A more sophisticated way to measure brand identification might be to test a number of consumers asking them to rate how strongly they identified the article with brand. A number of different brands items could be put out and subjects could be asked to group as many brand items as they could in a short period of time, and then we could measure how frequently the item was grouped with the other brand's items.

Brand identification is, of course, just one possible function for the aesthetic of an article. Let's look at a number of different functions of articles that may be derived from aesthetic elements of their design, which when combined with the data encoding function provide dual benefits.

### Establishing Trust

For many applications, there is a need for designs to not only encode data but also to establish trust with users or consumers.

In paragraph [0076] of the '013 application we discussed an imperfect pattern comprising a repeating trademark, wherein the data record establishes that the product is genuine, or provides manufacturing or ownership information about the article. However, the presence of the trademark in the pattern also builds trust in the consumer that the article is produced by the brand. Other elements that may also contribute to that trust are the color choices, the arrangement of the marks, or inclusion of other artwork.

In paragraph [0053] of the '013 application we described a food or beverage container which encodes data via an imperfect pattern. Through its aesthetics, the imperfect pattern may also establish trust that the food inside is fresh, healthy, nutritious, and tasty, or that it is from a trusted source. Graphic elements, color choices, and thematic designs may convey the dietary values of the brand that build trust with a consumer.

In paragraph [0055] of the '013 application we describe a series of cardboard boxes inscribed with an imperfect pattern that may convey a delivery address, the contents of the box, or to authenticate the source. But such markings on a box may also establish trust in the brand using the box or in the value of its contents, for example, by identifying the brand, by providing a recognizable set of graphic elements, and by using aesthetics to convey an image of quality.

Additionally, an imperfect pattern may wrap a drug packaging or container, encoding a batch number or serial number, for instance, but also establishing trust in the consumer that the contents are safe, authentic, intact or come from a company with integrity. It would be easy to imagine a graphic design that does not accomplish these goals, let's talk about how one would arrive at a design that measurably did achieve them.

Or, as another example, an imperfect pattern may be used as a security device, conveying a one time passcode, for example, but also communicating with an image consistent with the values and recognizable traits of the organization it is securing. The pattern, developing trust by conveying graphics that convey the values of the organization.

In each of these cases a functional outcome of an imperfect pattern may also be to establish trust with human subjects. Outcomes such as confidence in the authenticity of a product, quality of the product, or reliability of the data encoded based on the aesthetics of an imperfect pattern may be generated by using the process 200 of FIG. 2 of the present application.

### Increased Recognizability as a Functional Outcome

In other applications, recognizability is also key. A wristband may identify a person to provide access or track their whereabouts, for example at a resort or concert venue. Applying an imperfect pattern to the entire wristband (e.g. through repetition of the pattern) allows easy scanning independent of how the wristband has rotated around the wrist. While this is a great functional benefit on its own, imperfect patterns also allow flexibility on the appearance of each wristband, a trait which can have additional functional benefits.

Imagine that wristbands had different patterns on them that were easily recognized and distinguished from each other. For example, wristbands with one graphics aesthetic may provide its wearer with access to VIP areas, wristbands with an imperfect pattern displaying a different aesthetic may allow the wearer to go backstage. At each station where wristbands might be scanned to allow access to a certain class of persons, a human may first observe the design of the wristband to determine quickly, prior to scanning, if a person is authorized to access that area.

As another example, airline tickets may be printed or displayed such that instead of showing a common graphic code at the check-in gate, the ticket (paper or on a personal device) displays an imperfect pattern conveying important aspects of the trip or the traveler. Such imperfect patterns have several functional benefits, for example, being difficult to forge, or being easy to scan even if the ticket is folded, torn, or dirtied. But there are functions beyond improved scannability.

For example, if the traveller is a minor the ticket might be a graphic pattern that is kid themed, offering a friendly aesthetic for the traveller, but also allowing the gate staff to quickly identify customers who require special attention, even if electronic systems to read tickets are inoperable.

Similarly, a first class customer may have a more refined looking code, a business customer a more business class code, and an economy customer a basic appearing code, wherein each code encode the traveller information and can equivalently be scanned, but each code is also distinctive and quickly recognizable by airline staff, allowing partially sighted and colorblind employees to quickly differentiate tickets by providing visually distinctive aesthetics.

### Adapting Designs for Increased Functionality

In certain embodiments, an imperfect pattern is generated beginning from an artist-defined design, aesthetic template, or visual reference. The artist-defined design establishes one or more visual goals, stylistic constraints, or aesthetic boundaries that the generated pattern is required to maintain, while still permitting controlled variation of pattern elements for purposes of encoding a data record. The artist-defined design may include, for example, preferred shapes, spatial rhythms, relative proportions, visual balance, or other aesthetic characteristics that are preserved across pattern instances.

The capacity of an imperfect pattern to encode a data record is influenced by characteristics of the pattern design and the manner in which variations are applied. In some embodiments, the size of the data record, such as the number of bits encoded, is intentionally limited to improve robustness, decoding reliability, or aesthetic fidelity. Increasing the number of marks or graphic elements within the pattern, increasing contrast between marks and a background or between different regions of the pattern, or applying larger or more visually distinguishable transformations to the marks may increase the distinguishability of encoded values. In certain embodiments, multiple different transformations are applied to a given mark or group of marks. In other embodiments, the manifestations of one or more mark parameters are distributed such that they are observable approximately evenly across the pattern. In some implementations, marks are constrained to be roughly equal in size in order to promote uniform spatial sampling and reduce bias in decoding, although controlled variations in size may also be used as an encoding parameter.

In certain embodiments, the imperfect pattern is designed, trained, evaluated, or deployed within a defined use environment that further constrains the encoding and decoding process. By way of example, the pattern may be captured in a two-dimensional imaging context without substantial perspective distortion, rotation, or translation relative to an imaging frame. The pattern may be captured at higher image resolutions, under relatively consistent lighting conditions, or with reduced contrast variability. In some embodiments, the pattern is applied to substantially flat surfaces rather than curved or deformable surfaces, and image capture is performed with reduced motion blur or defocus. Such constraints may be imposed during training, during deployment, or both, and may be relaxed or tightened depending on the intended application.

Decoding performance and robustness may further depend on implementation choices. In various embodiments, larger or more complex decoding networks, longer processing times, or particular computational architectures may be used to improve accuracy or reliability. Certain embodiments employ incremental, staged, or continual learning techniques, in which decoding performance is improved over time as additional training data or observations become available. The selection of these implementation parameters may be based on available computational resources, latency requirements, or desired levels of robustness.

The use of an artist-defined design as a starting point inherently constrains the space of permissible pattern variations. Because the pattern must remain visually consistent with the designer's aesthetic goals, deviations from the design are limited to those that preserve the intended appearance. The encoding process therefore cannot arbitrarily vary parameters without violating aesthetic requirements. Any adjustment to the pattern balances visual appearance with encoding functionality, resulting in a smaller, more structured, and more predictable set of possible configurations. This narrowing of the search space facilitates reliable encoding and decoding while preserving artistic intent.

These aesthetic constraints further support enablement by providing clear guidance as to the range of permissible variations and by reducing the need for undue experimentation. Candidate pattern variations can be evaluated for compliance with both aesthetic constraints and decoding performance using objective criteria or straightforward verification procedures. As a result, a person of ordinary skill in the art is enabled to practice the invention across a wide range of embodiments while maintaining both visual integrity and reliable data recovery.

### Adapting Pattern Design for Scanning Performance

Recall from numerous embodiments of the '013 application (especially paragraphs [0308]-[0318]) that an imperfect pattern may be constructed to have a broad range of visual appearances. We have discussed a range of aesthetics in order to provide many secondary functions, such as to camouflage an article, to communicate a brand image, to simplify or streamline a user interface, or to match a predefined aesthetic.

The visual appearance of the pattern may also be adjusted broadly to provide best performance in the anticipated scanning environment, and with a particular data record payload size. As each application of imperfect patterns, from users scanning with cell phones, to high speed cameras, to checkout counters, introduces a different range of image qualities and degradation described in numerous locations in the '013 application (especially paragraph thereof). Additionally, equipment choice of camera and level of image compression may significantly impact scanning performance for different imperfect pattern designs.

The size of the data payload may also factor into the design of the imperfect pattern, wherein a larger payload may require more mark parameters to be expressed in the design, either as more marks in the design, more ways to vary the marks, a wider range of variation of the marks in order to maintain scanning performance with a pattern carrying a smaller payload.

Having diverse scanning environments and data requirements means that imperfect patterns optimized for scanning in different environments may have different visual appearances, for example, by choice of artwork, colors, and layout, or may have different transformations or limits to transformations.

For example, a low resolution camera system, or a camera system with lots of motion blur may not perform as well with delicate artwork as with broader more recognizable strokes. Similarly, selection of color to best perform in the target environment, or features that may survive the expected noise from sensor and image compression artifacts may produce superior results in that environment.

The design may also be focused around the required swatch size. For example an imperfect pattern may need to function in an environment where there are lots of obstructions to seeing the complete pattern, and we may wish to be able to recognize the payload based on ¼ or ½ of the area of a pattern unit of the imperfect pattern.

Alternatively, imperfect pattern designers may choose a balance between meeting an aesthetic goal and achieving scanning performance requirements, wherein visual fidelity and decoding robustness are jointly considered. In such cases, the pattern is designed so that adjustments made to support reliable scanning do not materially detract from the intended aesthetic, and conversely, aesthetic constraints are selected such that they do not preclude recovery of the encoded data record under anticipated capture conditions. This balancing may be performed during an initial design process, through iterative testing in representative scanning environments, or through training and evaluation of a decoder configured to operate within the resulting design constraints.

### Ensuring Uniform Decoding Performance

Recall that the training of imperfect patterns, for example, by the processes described in numerous locations in the '013 application (especially paragraphs and thereof) runs until a predetermined loss threshold is achieved. Recall also that the training process involves generating unique masks which selectively reveal only a swatch of the pattern, and that as the patterns are shifted randomly underneath the generated mask. To achieve the predetermined loss level, it is helpful if each swatch of the pattern enables a similar data encoding capability.

This data encoding capability is provided by the visible interactions of transformed marks present in the swatch. As such, in order to provide a uniform scanning performance regardless of which swatch of the pattern we are decoding, it is beneficial to have a fairly uniform density of marks configured responsive to the data record across the imperfect pattern.

It is also possible to measure the differences in performance across swatches of a pattern. For example, a number of randomly selected swatches of pattern, each made of approximately the same amount of imperfect pattern by area, but of different portions of that pattern, can be used to measure this relative scanning performance across the pattern. For instance, we could measure the decoding accuracy (or alternatively the payload loss) across each swatch of the pattern, and use the distribution of accuracy/loss values across the swatches to evaluate the uniformity of decoding performance.

Across many such swatches, it is also possible to generate a map of this scanning performance across the pattern. For instance, one may break the pattern up into a collection of predefined regions, for example by mapping the imperfect pattern to a rectangular grid of pixels, and then collecting a number of performance values (e.g. loss or accuracy) associated with each pixel in a swatch, for example, by storing a count and a total loss value in each pixel. By evaluating a number of swatches of the pattern, accumulating the results to each pixel, and then dividing the total loss by the count for each pixel, we can generate a map of average loss across the pattern.

It may be desirable to set a minimum level of uniformity for such performance, as measured, for instance, based on the difference or standard deviation of loss or accuracy across the individual swatches or across a map of average loss.

While the training process described in the '013 application minimizes a loss total for the imperfect pattern, training alone can only achieve uniformity of performance if equivalent data encoding ability is spread across the pattern. As such, it may be necessary, for instance, in a process such as 200 of FIG. 2 of the present application, to evaluate the uniformity of decoding performance by such a metric in the testing 206 of data encoding function of the pattern.

Where we fail to achieve the desired level of total loss or uniform decoding performance, it may be necessary to modify the pattern template 203 to add marks to portions of the pattern which have insufficient decoding performance, or to make the transformations of the marks in those portions to be more noticeable, for example, by increasing the predefined limits for transformation of marks.

### Functional Aspects of (Seamlessly) Repeating Patterns

Recall from numerous locations in the '013 application (especially thereof) that an imperfect pattern may repeat seamlessly across a surface. Seamless repetition of imperfect patterns has many functions. As described in numerous locations of the '013 application (especially paragraphs and thereof), a repeating pattern may be applied to a large surface, or even the entirety of an article such that the article may be scanned from any portion of the surface showing the pattern.

We may also seek to match a predefined aesthetic, for example, if an existing graphic design seamlessly repeats, to match that design, we would need to make our imperfect pattern also seamlessly repeat.

By placing marks across the repeat seam of a pattern unit, we are able to achieve several additional functional goals beyond matching a predefined aesthetic. For example, marks crossing the repeat seam may ensure adequate density of marks across the boundary such that we can achieve uniform decoding performance from arbitrary swatches of the repeating pattern.

If an imperfect pattern contains recognizable marks, for example, a trademark or artwork associated with a company or brand image, it is important for recognition (and validity of the marks) that each mark be reproduced as a whole without distortion. Reproducing the marks in whole (rather than just cutting off a mark at the pattern unit boundary) ensures that marks remain valid and recognizable.

In addition, seamlessly repeating patterns, with marks crossing the boundary of the pattern unit are expected in many applications, such as textiles and wallpaper. Cutting off marks at pattern repeats would make such patterns inapplicable to such applications. Additionally, in certain applications (like wallpaper) marks crossing the boundary which match up to their corresponding portion on the other side of a repeat boundary are necessary to ensure proper alignment of the patterns when they are installed.

### Revisiting the Decoding Process

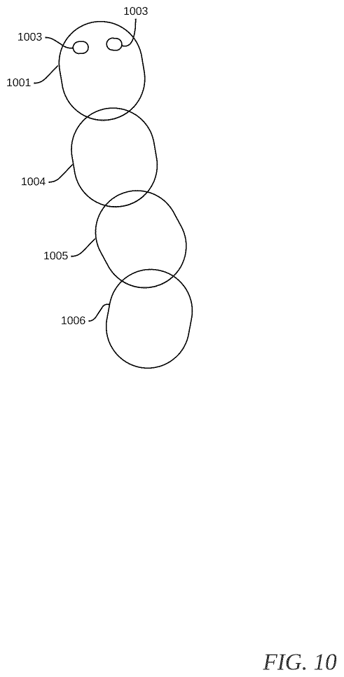

FIG. 10, illustrates an embodiment of a decoding process 1000 as described in paragraphs [0427]-[0433] and other sections of the '013 application.

A surface 1001 displays an imperfect pattern. The surface 1001 may be a surface of an article, and may be curved or have bends or folds. A digital camera 1002, connected to a computer system 1003, captures an image 1004 of the surface 1001, which may be pre-processed 1005 to produce a processed image 1006.

The processed image 1006 is processed by a decoder 1008 to produce a real-valued payload vector 1008. The payload vector 1008 is processed by a polarity discriminator 1009 to produce a binary data record 1010. The data record 1010 is processed by an error correction module 1011 which makes a determination of the validity of the data.

If the validity determination 1012 made by the error correction module 1011 is that the data is valid, then the decoding process returns the verified data record 1013, otherwise, the decoding process returns no pattern detected.

Payload Validation from Real-Valued Inputs

Recall from numerous locations of the '013 application (especially FIG. 24 thereof) that the encoder module may output a real-valued payload vector (with a length of the number of encoded bits), which is converted by a discriminator such as a polarity test to produce a corresponding binary payload of the same number of bits. After this process, an error detection and correction module makes a determination as to the validity of the payload. While this process works well and can have an extremely low error rate, in other embodiments we may use additional information to make determinations of validity.

In one embodiment, we may modify our decoder training process or any process described herein (especially process 800 of FIG. 8 of the present application) to generate a confidence output associated with each bit of the payload vector output.

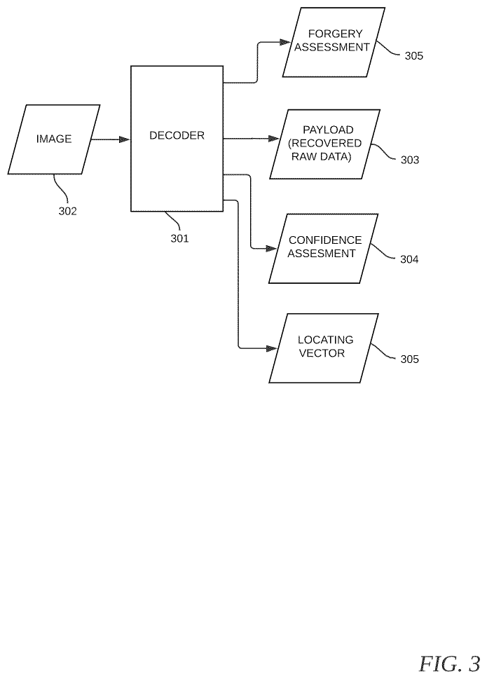

FIG. 3 of the present application depicts a decoder module 301, potentially comprising a machine learning model and receiving an image 302 as input. The decoder module may be trained to output a payload vector 303 and a confidence assessment 304, the confidence assessment potentially comprising a vector with a confidence value associated with each bit of the payload. Alternatively, the confidence assessment 304 may comprise a single value representing confidence in the validity of the payload vector as a whole.

In one embodiment, the creation of a decoder module 301 with confidence assessment output 304 may be accomplished by training the decoder module, for example with the training process depicted in process 800 in FIG. 8 of the '013 application, but with inclusion of an additional loss component, “confidence loss”.

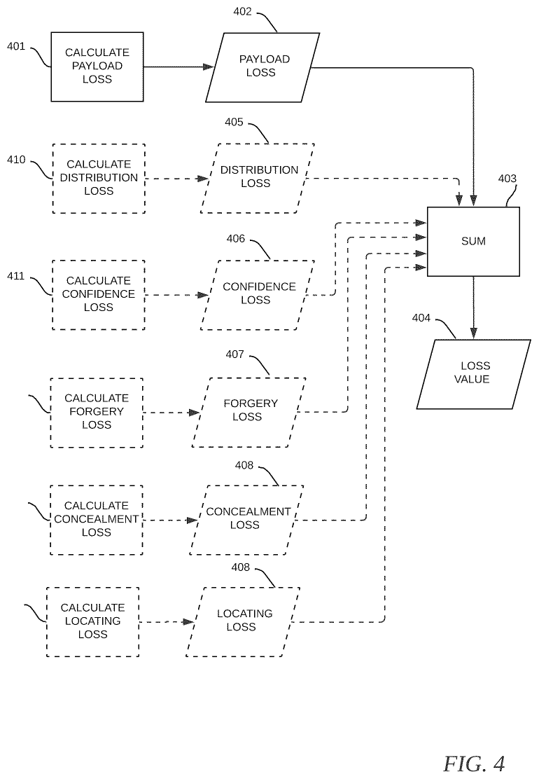

As depicted in FIG. 4 of the present application, we may calculate 411 a confidence loss 406, which may optionally be scaled (for example, by 0.1), and summed 403 with the payload loss 402 (as well as any other loss components of the embodiment) to produce the total loss value 404 used by the optimizer of the training process.

The confidence loss 406 may be calculated, for example, by measuring a binary cross-entropy loss:

$${L}_{confidence} = - \frac{1}{nb} {\sum }_{i = 1}^{n} {\sum }_{j = 1}^{b} {( {t}_{{i}_{j}} \cdot log ( c ) + ( 1 - {t}_{{i}_{j}} ) \cdot ( 1 - log ( c ) ) )}^{2} ,$$

where ‘n’ is the number of data records, ‘b’ is the number of data bits in each data record, and tᵢ_{ⱼ}=(Iᵢ_{ⱼ}==Oᵢ_{ⱼ}), where lᵢ_{ⱼ} represents bit j of data record i of the training batch, and Oᵢ_{ⱼ} represents bit j of decoded data record i of the training batch.

In another embodiment, one may extract additional information from the real-valued aspect of the payload vector not present in the recovered discriminated binary payload. Recall from numerous locations the '013 application (especially FIG. 24 thereof) that the decoder module 2402 may produce a payload vector 2403 of which each element is discriminated 2404 to produce a binary payload. Recall also that the decoder may comprise a machine learning model, and that model may have many pathways which drive the output for each bit towards one polar extreme or another. Thus the degree of each bit output towards a polar extreme may indicate a degree of confidence in the validity of that bit. We may assess confidence in the entire payload by ensuring that the absolute value of every element of the payload vector 2403 exceeds a predetermined value (e.g. 0.5).

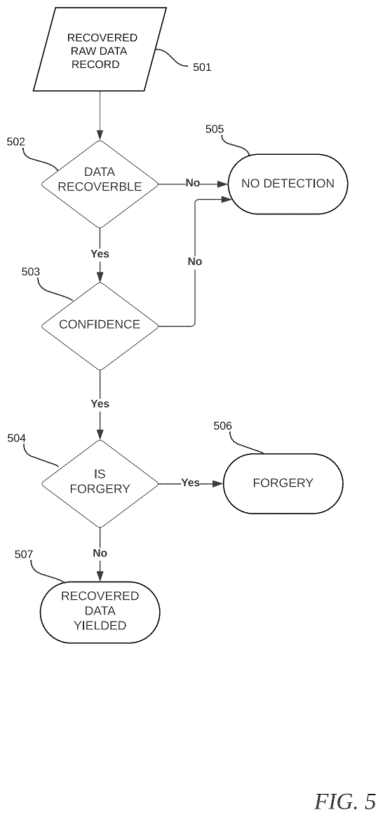

FIG. 5 of the present application depicts an embodiment of how a decoder may be adjusted using a confidence assessment, including an assessment of any of the described methods. A recovered raw data record 501, which was recovered, for example by a process in which an imperfect pattern decoder module generates a payload vector which is discriminated to yield the recovered raw data record 501. The raw data record 501 may be processed by an error detection and/or correction module to verify the validity, or potentially to recover the encoded data record, or alternatively to yield no data record if the data record cannot be verified and/or recovered.

Recall that the decoder may also generate a confidence value predicting the validity of the output payload, and that the decoder may also generate a forgery output predicting if the imperfect pattern is not genuine.

Thus there are three tests that may be a part of the decoding of an article: whether the data is recoverable 502 (from the error detection and/or correction module), whether the encoder output signals confidence 503 in the decoded raw data record, and whether the encoder signals that imperfect pattern to be a forgery 504. Each of these tests is optional and may be combined in any order to produce similar results.

If the data is not recoverable 502, then no detection 505 is yielded. If the data is recoverable 502, then we check the encoder's confidence 503. If there is low confidence (e.g. the confidence output lower than a predetermined value), then we also yield no detection 505.

If there is high confidence (e.g. the decoder's confidence output is greater than the predetermined value), then we proceed to check for forgery 504. If the decoder forgery output indicates a forgery (e.g. by comparison to a predetermined threshold value), then a forgery output is yielded 506, otherwise the recovered verified data record 507 is yielded.

Various figures included herein (especially FIG. 3 of the present application) illustrate additional configurations of the decode process that use the additional information of the real-valued outputs and/or the confidence outputs to make a more accurate determination of presence of an imperfect pattern and the accuracy of any recovered payload.

### Simplified Encoder Models

Recall from numerous locations of the '013 application (especially paragraphs [0017], and [0164] thereof) that an encoder may comprise a machine learning model, for example a model composed of one or more fully connected layers. While the decoder must be able to successfully extract a payload under a wide variety of conditions such as when the imperfect pattern is distorted by curvature of the surface, or by perspective, or when the pattern is partially occluded, it requires a great deal of capacity (as measured, for instance, by layers of depth in a convolutional network). The encoder, however, does not require a great deal of complexity. In fact, in a preferred embodiment, an encoder comprises a neural network consisting of a single layer with an identity activation function, which is equivalent to a single matrix multiplication and addition of bias vector:

$$p = M \cdot d + b ,$$

where d represents the vector of data bits, M is a matrix mapping data data bits to mark parameters, and b is a bias vector (a constant offset added to the result.)

### Pre-Processing Configurations

Recall from numerous locations of the '013 application (including paragraph [0429]) that preprocessing may include operations such as scaling, cropping, or enhancing contrast or color. Let's examine different approaches to preprocessing in preferred embodiments that may result in a higher decode success rate.

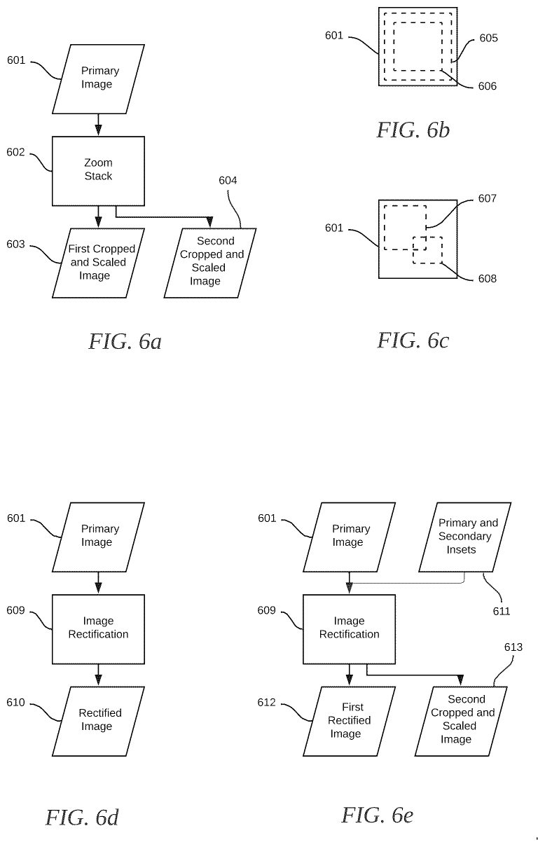

A user of a decoder may point its camera at a surface displaying an imperfect pattern. Attempting to scan the surface, the user may place a crosshair or reticle to guide them to point at the surface with the camera. Thus the surface may be in sight but at an unknown distance from the camera. In such situations, one approach to increasing decode rate is depicted in FIG. 6A of the present application.

A primary image 601 may be captured at a higher resolution than is necessary to decode. In fact, it may be typical to decode images of a resolution a few hundred in each dimension, but images may be captured at a resolution of thousands of pixels in each dimension. In addition to simply scaling down the image, we may instead apply a “zoom stack” 602 which simulates an optical zoom, generating a first cropped and scaled image 603 and a second cropped and scaled image 604.

As further depicted in FIG. 6C of the present application, the primary image 601 may have a resolution of 2048×2048 and the zoom stack preprocessor may generate output images each 512×512 for decoding. A first image crops a 10% margin 606 from the primary image 601 and scales the result to 512×512. A second image crops a 30% margin 606 from the primary image 601 and scales the result to 512×512. Each output image may then be processed with the decoder and if either decode passes the error detection and correction module or its data record is otherwise validated, its payload is yielded.

As an alternative, we may not know that the surface displaying the imperfect pattern is centered in the image. In such situations, a zoom stack such as depicted in FIG. 6C of the present application may be used to increase scanning success rates. A plurality of subregions within the image are generated, for example by a random placement within the image that adhere to a minimum and maximum size, and the generated subregions (depicted by a first subregion 607 and second subregion 608) each may be cropped and scaled, the resulting images each analyzed by a decoder and verified data record yielded if any of the decodings are deemed valid.

As depicted by FIG. 6D of the present application, preprocessing may also comprise image rectification, wherein the source image 601 is processed by an image rectification module 609 to produce a rectified image 610. The image rectification module module may zoom, crop, or reorient the imperfect pattern apparent in an image in order to remove effects of perspective or surface curvature and isolate the pattern from the image background. The image rectification module may, for example, comprise U.S. Pat. No. 11,704,767 titled “Texture Extraction” wherein a neural network is trained to recognize the pattern on curved surfaces from various vantages and to be able to create a rectified image 610 from the primary image 609.

In a preferred embodiment, as is depicted in FIG. 6E of the present application, the primary image 601 is processed by the image rectification module 609, that module also taking as input a primary and secondary insets 611, for example the margins depicted in FIG. 6B of the present application or FIG. 6C of the present application, and cropping of the rectified images according to those margins, either prior to or after the rectification, to produce a first rectified image 612 and a second rectified image 613 corresponding to the primary and secondary insets 611.

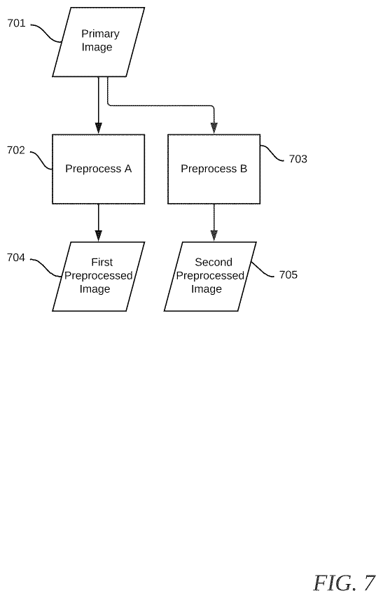

As depicted in FIG. 7 of the present application, as part of a decoding process, a primary image 701 may be processed by different preprocessors as depicted by preprocess ‘A’ 702 and preprocess ‘B’ 703, wherein preprocess ‘A’ 702 processes the primary image 701 to produce a first preprocessed image 703, and preprocess ‘B’ 703 processes the primary image 701 to produce a second preprocessed image 705. Preprocess ‘A’ and preprocess ‘B’ may be distinct preprocessors with different approaches, for example different combinations of preprocessing techniques described herein. Both the first preprocessed image 704 and second preprocessed image 705 may be fed as input into a decoder, and if either results in a validated data record, that data record may be yielded.

FIG. 8 of the present application depicts an embodiment with two preprocessing methods in a more complete decoding pipeline 800. A digital camera 801 connected to a computer system 802 captures an image 804 of a surface 805 displaying an imperfect pattern. Preprocessing 806 of the primary image 804, which may for example comprise any combination of preprocessing techniques described herein, produces a first processed image 807 and a second processed image 808.

The first processed image 807 and the second processed image 808 are each evaluated by a decoder 809 to produce a first payload vector 810 corresponding to the first processed image 807, and a second payload vector 811 corresponding to the second processed image 808. Each payload vector is then processed with a polarity discriminator 812 in order to produce a first raw data record 813 corresponding to the first payload vector, and a second raw data record 814 corresponding to the second data record 814.

The first raw data record 813 and second raw data record 814 are each processed by an error detection and correction module 815 (or some other verification scheme as described herein), and if the first raw data record 813 is verified as valid 816, the verified data record 817 is returned. If the first raw data record is not valid, we may test the validity 818 of the second raw data record 814. If the second raw data record 814 is valid, the verified data record 817 is yielded, otherwise no output 819 is yielded.

### Decoding Arbitrary Patterns

Recall that a decoder may be matched to an encoder, for example, the encoder and decoder pair may be co-generated through an optimization process such as the process 800 in FIG. 8 of the '013 application. While such a cogeneration method does produce a very highly performing decoder, the decoder is matched to a specific encoder.

In some applications, this is ideal. But other applications, for example, an application which scans multiple articles bearing different imperfect patterns (not just with different data records, but generated from different pattern templates) would benefit from not requiring any user intervention to select the appropriate decoder.

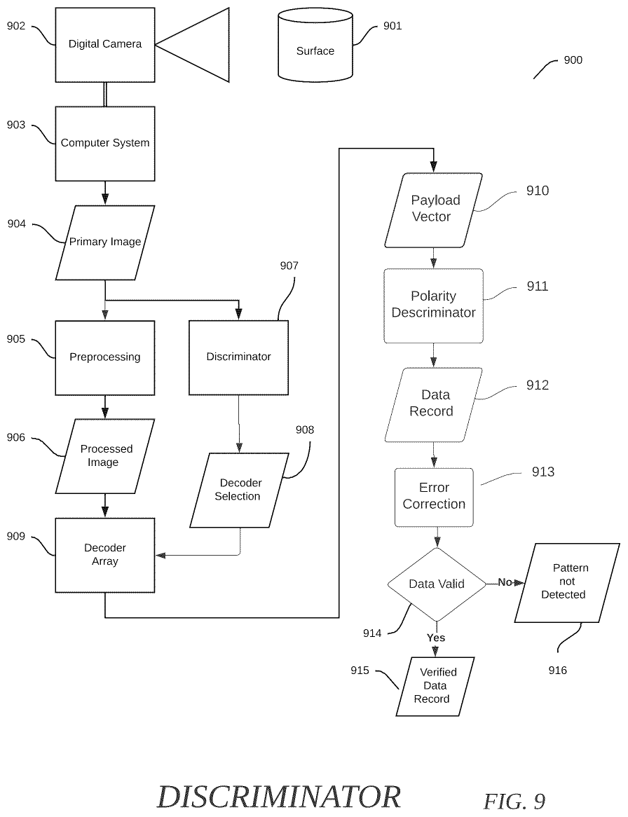

FIG. 9 of the present application, illustrating process 900, shows a method to decode an arbitrary imperfect pattern, by selecting a decoder specific to the pattern. A surface, 901, displays an imperfect pattern. The surface 901 may be a surface of an article, and may be curved or have bends or folds. A digital camera 902, connected to a computer system 903, captures an image 904 of the surface 901, which may be pre-processed 905 to produce a processed image 906.

The captured image 904 is also processed with a pattern discriminator 907 to produce a decoder selection 908. The decoder selection, for example, may be the name of the pattern template used to generate the imperfect pattern detected. If no decoder is selected, the process may terminate at this point.

If a decoder selection 908 is made, it is passed to a decoder array 909, where the decoder specified by the decoder selection 908 is used to decode the image 909 and produce a payload vector 910. The payload vector 910 is processed by a polarity discriminator 911 to produce a raw binary data record 912. The data record 912 is processed by an error correction module 913 which makes a determination of the validity 914 of the data. If the data is determined to be valid, the verified data record 915 is yielded, otherwise, no pattern is detected 916 and no data is yielded.

### Different Encodings of Same Pattern Template

Recall from numerous locations of the '013 application (especially process 800 of FIG. 8 thereof) that encoder-decoder pairs may be cogenerated through a machine learning process of loss optimization. While this process determines an optimal encoding scheme for the graphic pattern and scanning environment envelope, the encoding scheme is also somewhat arbitrary.

As described in numerous locations of the '013 application (especially paragraph thereof), the encoder and decoder models have parameters that control their function, and that at the start of training, those parameters are initialized with random values. Recall also that the training images are created through processes that are controlled by random values.

As such, the resulting encoder-decoder pair and the encoding scheme they embody is not based solely on the pattern template, and successive training of the encoder-decoder pair results in pairs which can communicate within constrained pairs of encoder-decoder, but not across cotrained pairs.

In some applications of imperfect patterns, we may wish to use a private decoder feature to limit access to data. (Recall in numerous locations of the '013 application (especially paragraph thereof) that the imperfect pattern may be used as an encryption device.)

In such applications, we may wish to change the encoding schema from time to time in order to prevent access to encoded data for those with an outdated reader. This is easily accomplished by retraining the encoder-decoder pair with a different random seed, generating different random values for the parameters (which may be weights and biases of the model, for example).

For example a first encoder-decoder pair may be generated by a first random seed, resulting in the first initial condition of encoder and decoder models, and a first set of generated training images which are used to train the models. A second encoder-decoder pair may be generated by a second random seed, resulting in a second initial condition of the encoder and decoder models, different from the first initial conditions, and may be trained with a second set of generated training images. As a result, the first encoder produces a pattern readable by the first decoder, and not readable by the second decoder. Similarly, the second encoder produces a pattern readable by the second decoder, but not by the first decoder.

The benefit of such a retraining is that, while the aesthetic captured in the pattern template has not changed, one can generate multiple patterns comprised of the same graphic elements, undergoing the same transformations, to generate sets of patterns that look largely alike remain as separate private encoding schemes.

As an example of use, we may use an imperfect pattern as a security device, encoding an encrypted identity which is conveyed visually to a computer. From time to time we may wish to change the encoding scheme in order to prevent unauthorized access, or in case the encoding scheme is somehow leaked outside the organization.

### Training Loss Components

The '013 application describes in numerous locations (especially FIG. 8 thereof) a training process which iteratively develops an encoder model and decoder model by calculation of a gradient of the loss value which guides an optimizer to update the parameters of the models. The loss value, for example, may be calculated based on differences between the data record encoded into the training images and the data records outputs of the decoder. FIG. 4 of the present application depicts various compositions of such a loss value.

In one composition, we calculate 401 a payload loss 402. The payload loss, representing a difference between the data records encoded into the images and the data records extracted from the images, is summed 403 (a unity operation if it is the only loss component) to produce the loss value 404.

However, in other compositions of the loss value, we may wish to include other loss components such as a distribution loss 405, which may serve to drive the statistical distribution of mark parameters across a set of articles to a predefined distribution, a validation loss 406, which may serve to train the decoder to signal when it determines it has valid output, a forgery loss 407, which may serve to train the decoder to signal when it determines its input is a inauthentic or counterfeit, and/or a concealment loss 408, which may serve to train the decoder to make imperfect patterns less detectable by machine vision object detection systems (other than the decoder). Any combination of such additional loss components may be computed and summed 403 together with the payload loss 402 to produce enhanced decoder capabilities.

As an example, recall from earlier in the present disclosure that an imperfect pattern may be designed as a camouflage that serves to hide the detection of an object by a person or computer vision system. In accordance with FIG. 2 of the present application, we may test for this dual function as part of a design iteration loop, allowing a designer to make iterative changes to the pattern template until the function is achieved.

Working within the constraints of a set pattern template, however, one may still improve a design to make it less detectable. To illustrate, recall that the camouflage pattern described in paragraphs [0269]-[0276] of the '013 application is composed of four layers, each contributing a different color to the pattern by thresholding a continuous field interpolating between points controlled by mark parameters.

This approach creates patches of color, but it may be that large patches of color in an imperfect pattern are more detectable in a machine vision object detection system, or it may be that concentric patches are more detectable than partially overlapping patches. In fact, there may be qualities of the color patches we have not thought of that do affect the detectability of the pattern, and there is a way that we can optimize all such qualities to minimize detectability. One may potentially also add more color layers, or allow the color of each layer to be generated from one or more mark parameters (R,G,B, for example).

A concealment loss 408 may be calculated 409 during training by synthesizing an image of a surface displaying an imperfect pattern, the surface placed together in the image with typical backgrounds for the camouflage function (backgrounds, for example, that look like places the camouflage will be used). A machine vision system, designed to detect any objects of a select set of object types, is integrated into the training process such that each imperfect pattern generated as part of training is also put on objects from the set (on top of the backgrounds) and that image is fed to the machine vision system.

The machine vision system may be configured as a function of training and returns a value indicating how confidently it has detected an object of the select set. To calculate 409 concealment loss 408 for the batch, the detection values for the batch are totaled up and may be scaled down by a scale factor (e.g. 0.001) to lessen the weight of influence of the concealment loss (leaving payload loss to be the most influential component of the total loss value 404. Thus, the concealment loss contribution will very slightly adjust the manner that mark parameters are expressed such that it lessens the detectability of the resulting imperfect patterns in the machine vision system.

### Scanning Output Confidence

Recall from numerous locations of the '013 application (especially paragraph thereof) that an imperfect pattern contains no visual features to identify the presence of the data encoding pattern, and that the pattern has no locating devices to lock in on. Recall also from numerous locations of the '013 application (especially paragraphs [0430]-[0433] thereof) that the presumption of the presence of an imperfect pattern in an image and the extraction of the associated verified data record happen simultaneously at the stage of the error detection or correction module.

A system, such as any system described herein (especially the system of FIG. 1 of the present application) has a camera which may be streaming images, the images processed by a decoder and the output of the decoder converted into a binary string of bits. The string of bits is further analyzed by an error correction and detection module. This module, for example, may be an implementation of a Reed-Solomon error correction algorithm which makes a statistical determination based on the combination of data bits and error correction bits of whether a valid payload is present or can be reliably extracted.

An important point is that if the camera is not presented an imperfect pattern but rather just collects random images of the world, and those images are processed by the decoder, the decoder, having no knowledge of the content it is viewing but outputting a real valued payload vector regardless, is outputting essentially random payload vectors.

A feature of the error detection and correction module is that with sufficient bits allocated for error correction, it becomes statistically improbable to have an incorrect read or false positive. This is generally sufficient protection, however, in some applications, it is helpful to further reduce this rate of false positives, which may be reliably improved by adding an encoder confidence output.

In a preferred embodiment, the decoder makes a prediction of the presence of an imperfect pattern which can be used to further reduce the false positive rate. Various embodiments described herein may include this feature.

### Generic Encoder

A system that allows for graphic designs to be altered to robustly convey a verifiable digital payload without training a new encoding scheme would be of value.

The '013 application lays out a system requiring training, but the system has many techniques and benefits that we can build on to create a system that can work without training. Let's first review the approach of the '013 application for encoding information in the form of imperfect patterns.

A stated goal of the '013 application is to simultaneously visually communicate an emotional message, in the form of the aesthetics of the design, and a data message of a binary pattern encoded in the design. Let's discuss a bit about ways that could play out.

For instance, let's say that the imperfect pattern is being applied to a product packaging, and is used to track the product from manufacturing to point-of-sale. The graphic design on the packaging is intended to serve multiple purposes.

Of course, the design must serve the data encoding function, the design must allow for a binary payload to be expressed through the pattern, such that the product can be scanned from any side in which a portion of the pattern is visible. But the pattern must also serve one or more functional aesthetic purposes. The design must project an image that is consistent with the brand, and should make people want to buy the product. Thus, the aesthetic elements are not there simply for ornamentation or decorative embellishment, but rather serve a functional aesthetic purpose.

Let's examine how one can arrive at a design that may serve both data encoding purpose and a functional aesthetic purpose. Imagine we have a product we would like to track, and the product displays an imperfect pattern on its packaging. The imperfect pattern allows the product to be scanned from any side on which the pattern is present to identify product data like its SKU (Stock Keeping Unit) code, manufacturing date, batch number, allergen information, expiration date, recyclability, or supply chain path.

The imperfect pattern also decorates the package to communicate other information visually and to emotionally affect the consumer. For example, the design could cause the consumer to recognize the brand, or to favor the brand's product over a competitor's differently packaged product. As another example, an imperfect pattern applied to an article of clothing should appeal to the consumer who would wear the clothing, while also being able to be scanned (to communicate a payload or verify authenticity).

Similarly, an imperfect pattern may be used to communicate a security password (such as a temporary one time password), while also branding the authentication system with a graphic that identifies the organization and inspires confidence in its users.

The key to arriving at a pattern design that visually communicates at two levels simultaneously, a first level of functional data communication to a machine and second level of functional aesthetic communication to a human, is an iterative process that refines designs based on user testing feedback.

FIG. 2 of the present application illustrates a system for producing an imperfect pattern design that can be applied to an article to achieve both data communication and functional aesthetic goals. An artist, which may comprise one or more human artists or machine learning or artificial intelligence programs that is capable of producing artwork, determines a desired aesthetic 201 to be adapted as an imperfect pattern. The concept may include graphic elements, their suggested arrangement, color choices, and how the elements might be varied in data encoding variants of the design concept.

The desired data payload size 202 is determined, as well as the scanning requirements 203 (for example, the range of angles, lighting conditions, degradation, etc. for which scanning should be successful.) The desired aesthetic 201 and data payload size 202 are used as the basis for constructing an initial pattern template 204. The pattern template may, for example, place a number of graphic elements in the design that are controlled by mark parameters configured by an encoder.

The pattern template 204 and scanning requirements 203 are used (for example by a training process) to generate an encoder-decoder pair 205. The encoder and decoder are tested 206 to determine if both the aesthetic function (evaluated through subject testing) and the data encoding function (tested through real and simulated interactions) has been achieved. If testing 206 yields adequate performance, then the dual use design is complete 207. If performance is not adequate, the aesthetic of the design (for example, the choice of graphic elements, their density or placement, etc.) can be refined 208 and a new design template may be created 204. The iteration of designs continues until the test for dual function 206 yields a complete dual-use design 207.

### Generic Encoder-Decoder Applications

The '013 application describes various embodiments of a system in which a data record, comprising a plurality of binary bits, is robustly encoded into perturbations of a design such that the data record can be extracted and verified from an image displaying a portion of the design.

The article of the '013 application conveys the data record by displaying marks on its surface, the marks being perturbed from their configuration in a design template, and being transformed within prescribed limits, the transformations controlled by a set of mark parameters which are responsive to the data record.

The problem of how to best encode a binary payload into the mark parameters of the design may be worked out through a process of training a cooperative pair of machine learning models in a simulated 3D environment.

This training process results in an encoding scheme (embodied in separate encoder and decoder models) which is optimized for the specific design and the environment in which it is expected to be read. For instance, by training with only random portions of the pattern visible, the encoding scheme learns to distribute an individual data bit across perturbations of many marks, such that no specific portion of the pattern is necessary to decode it. Similarly, if a mark is not good at visually conveying information (if faint, or obscured by other design elements, for example), it will not be relied upon for the encoding of information.

As such, the encoding scheme for a the '013 application pattern is optimal for the specifics of the pattern. This is a highly desirable trait-leading to significant gains in code readability, but for some applications the requirement of training to develop a bespoke encoding scheme presents a significant time and compute cost.

For example, let's look at the the '013 application process applied to the problem of encoding data into an image (such as a PDF) of a text document. Let's say the document is a legal memorandum consisting of many pages of text, and we would like to secretly encode a digital identity into each page such that after distributing differently encoded versions of the memos to a set of individual, we can locate which individual has made an unauthorized disclosure of the memo. (USPTO publication US2024/0304018 A1, hereafter referred to as ‘US'018’, presents this exact use case for encoding a trackable identity into a page of text by making perturbations to the text).

For this application, as solved with the the '013 application methods, each page of the memo would require a different pattern template. The individual marks of each page would be composed of renderings of text elements (letters, words, or phrases) that would be perturbed, for example by adjusting position or scale, and composited together to form an imperfect pattern of the page of text.

A memorandum consisting of hundreds of pages of text, encoded with an serial number by the '013 application would require each page to be submitted to a time consuming training process in order to yield the encoder-decoder pair specific to that page.

In contrast, US'018 method also perturbs graphic elements on the page to encode a unique identity, and it does not require training for each page of text as with the '013 application. However, US'018 does not encode a data record, or digital bits, but rather provides a unique analog signature for each copy of the document, requiring a compute intensive comparison to each individualized copy of the document, followed by human decision making on the quality of the match.

As the '013 application requires expensive training for each page, and US'018 requires intensive computation at scan time and is not definite in its results, neither of these methods is ideal for this particular application.

In other applications of imperfect patterns of graphic design, such as production of a large variety of data encoding graphic designs, it would also be desirable to have a generic encoding scheme that could be used without training to encode data using pattern templates.

A solution that would allow a definitive verifiable data record to be encoded into perturbations of marks of a design without requiring the encoding scheme to be generated by training specific to the design would be of great benefit.

### Generic Encoding Methods

Now that we have reviewed the abilities of imperfect patterns described in the '013 application, let's explore how we can extend the system to embodiments in which a generic encoding scheme can be applied to add a digital payload to any design or document.

Recall that a benefit of the physical simulation in the co-training process of the '013 application is the distribution of the data payload across the mark parameters. Another benefit of that training is the decoder learning to recover the data payload without information on any particular mark parameter. Though this is optimally done through the process of simulation as with the '013 application, we can somewhat emulate the effects of selective masking through a training process that has no spatial reference.

An alteration may be made to the methods described in the '013 application that allows for encoding of imperfect patterns without an encoder that is customized to the pattern template. Rather a “generic” encoder, not possessing knowledge of what a mark parameter may be adjusting in a pattern template is substituted in for a pattern specific encoder. While such an encoder may not be optimal for the pattern template or application, it still can serve to encode information robustly into a pattern.

As an example let's look at an imperfect pattern of a text document, wherein sections of text are marks, and the sections of text may shift a bit to the left or to the right based on the mark parameters output by the generic encoder. We may capture an image of this document which includes just portions of the page, so we don't want to rely on any specific portion to successfully decode the payload.

In some circumstances, it may be possible to recover the mark parameters from the image. For example, using photogrammetric techniques, we may locate certain features, such as a left margin and measure the distances of each section of text from that locating feature. In such cases, we may feed mark parameters recovered from an image of an imperfect pattern into a generic decoder co-trained with the generic encoder to recover the data record.

### Generic Encoder Generation

Creation of a generic encoder can be straightforwardly constructed, for example, based on a machine learning model. A machine learning model for a generic encoder may be trained, for example, as part of a co-training problem in concert with a generic decoder. The following source code of a PyTorch application illustrates how such an encoder may be constructed as part of a generic encoder-decoder pair.

Encoder and decoder models are initialized with random values. An iterative training process then refines the parameters of each model. In each iteration, a batch of random data records are generated, and then processed by the encoder to produce mark parameters. A binary mask maps to a random selection of mark parameters which may be observed, and the complementary portion of unobserved mark parameters have their values cleared so they cannot influence training. Mark parameters are also degraded with random noise added to them, in order to make the decoder robust to inaccuracies of measurement.

Next the decoder model takes as input the observation mask as well as the degraded mark parameters and attempts to recover the original data records. The difference between the random data record and recovered data records are measured, and used to generate a loss value. The loss value is then backpropogated and used to find a gradient to slightly adjust the parameters of the encoder and decoder models.

This iterative process may proceed a fixed number of steps, or until a predefined loss or accuracy is measured. One example may use the pytorch source code described in paragraph 00325 of the provisional application of the present application through paragraph 00418 of that provisional application.

### Mark Parameter Recovery

In more common circumstances, it may not be practical or even possible to recover mark parameters used to generate an imperfect pattern. the '013 application discloses many types of marks, for all marks, the forward process of rendering the mark to an image layer is fairly simple. The same cannot be said for a process to convert an image into the set of mark parameters of each of the marks—This problem is incredibly challenging for some marks.

With composite marks, where we do not know where the constituent marks are delineated. For height field based marks such as isocontours and thresholding, we know at best the relative values between mark parameters at the corners of the cell, and in many cases the information is simply lost because it is outside of the range of the threshold. And for deformation and 3D rotation based marks, we would have to undertake a reconstruction to figure out the mark parameters.

For affine transformations such as translation, rotation and scale, the mark parameters are more directly related to their renderings, however, when an imperfect pattern is applied to the surface of an article, there typically exists no frame of reference to measure the mark parameters. As such, the best we can do is to measure the transformations between marks.

One approach is to generate a set of observations based on relationships between marks. For example, we may recognize two adjacent portions of text, and as performed in US'018, and measure the spatial relationship between the two portions. We may see other pairs of marks that we may measure relationships between (such as relative positional, color, or shape information), and then use those measurements to decode the pattern.

In one embodiment, a matrix mapping the relationship between each pair of marks is assembled based on whatever information we can measure between recognized marks. The matrix is sparse as most marks are not adjacent or may not be seen in concert. Along with each set of relational values is a flag indicating whether the relationship has been measured. A decoder may be trained, by converting mark parameters into a relative matrix, to decode data records based on the matrix of relative values.

While the previous approach requires the identification of each mark, there are other approaches tied to a specific pattern template that can use a machine learning model to bypass that step. For example, the standard co-training approach illustrated in various figures of the '013 application (especially FIG. 8 thereof) may be slightly altered to produce a robust decoder of images containing a swatch of pattern.

Recall that the encoder and decoder are typically initialized with random values with their parameters (e.g. weights and biases), and then those values are optimized during training. Instead of doing that with both models we randomly initialize and alter only the decoder machine learning model. The encoding model is initialized with a generic encoder, such as the generic encoder generated from the above source code.

The training process proceeds as usual with the generation of training images based on mark parameters generated by the encoder. The training images are fed into the decoder module, which outputs the recovered data record. A loss value is generated by measuring the difference between the random data records used to create each image and the data record recovered by the decoder. As the loss is backpropagated, it need only carry through the pipeline to the decoder module, saving us the computation and memory necessary to backpropagate all the way through the rendering process and into the encoder.

### Hierarchical Marks

Recall from process 200 of FIG. 2 of the present application, that an imperfect pattern may seek to achieve two functional outcomes simultaneously, the conveyance of digital information, and a functional outcome innately tied to the aesthetics of the pattern such as its streamlining of a user interaction, establishment of trust, or increasing the likelihood that a human subject will perform an action.

Recall also that the encoder and decoder may be co-trained together using visually simulated images showing only a portion, or swatch, or the pattern. That shape of each training swatch is generated through a process, such as the random combination of two oddly shaped masks. This random generation of masks creates an infinite variety of swatch shapes all approximately the same area. Naturally, as a result, the area of the swatches scannable by a decoder from real images of portions of pattern is the same area of the portions in training.

As an example, the combination of masks applied to a swatch may be configured to a predefined percentage of the pattern, for example 50% of the area of the pattern unit. When trained successfully, as determined by achievement of a predetermined decoder accuracy, the decoder is able to decode real images with swatches of the pattern of the same 50% percentage. A pattern that fails to train to the predetermined accuracy threshold may fail because it does not provide sufficient number or uniformity of density of varying marks.

Of course, a portion of an imperfect pattern that contains no varying marks cannot possibly convey a data record. For example, if we train the encoder and decoder with an imperfect pattern positioning varying marks in just a corner of the repeating pattern, then images capturing swatches not including that corner would not scan. In order to establish uniform scanning performance from equivalently sized swatches of the imperfect pattern, one must distribute varying marks throughout the pattern so that the observable effects of data record driven interactions between marks is roughly the same in equivalent area swatches of the pattern.

The wide variety of mark transformations described in the '013 application allow a pattern template designed around the functional aesthetic to be expressed a set of imperfect patterns that fit with the predefined aesthetic or functional goals of the pattern, however, there are sometimes circumstances where the matching a predefined aesthetic or using an aesthetic for a functional goal means using large graphic elements which occupy a sizable portion of the pattern, and that limits any measurement of interactions between mark parameters.

In order to introduce more observable variation into a large element, one might create a deformation lattice, for example, and deform the large element with a sufficient number of control points in the lattice (the position and/or orientation of which are controlled by mark parameters) to have sufficiently observable variation, however doing this may detract from the functional goal tied to aesthetics. For example, a functional goal may be that the aesthetics of the pattern cause a user to reliably recognize the brand of the product at a higher rate, or it may affect simulated purchasing in consumer testing.

One way to preserve the desired aesthetic but maintain data encoding capability across larger elements is to have some mark's placement in the pattern space made relative to the placement of another mark.

FIG. 10 of the present application illustrates an imperfect pattern 1000 comprising a set of marks arranged in a transformation hierarchy.

A snake is composed of several segments. A first segment 1001 represents the snake's head wherein a right eye 1002 and a left eye 1003 are placed on the head. The position of each eye moves with the head, but also moves relative to the head based on the transformation of the eye relative to the coordinate system of the head.

This can be accomplished by a hierarchy of transformation of marks. For example, a set of mark parameters is assigned to control the head by controlling x-translation, y-translation, and rotation for the head, the transformations made relative to the coordinate system of the imperfect pattern unit. Additional sets of mark parameters for x-translation and y-translation are assigned for each eye of the snake, but these translation values are made respective to the transformed coordinate system of the head.

The arrangement is described in a hierarchical graph in the form of a tree. Each mark is assigned a parent mark, or no parent in the case of root elements of the tree. The local transformation of a mark may be represented, for example, as a 3×3 matrix describing the rotation, scale and translation of the mark. As each mark has a local transformation, if a mark has a parent, the total transformation of the mark becomes a concatenation of the mark's local matrix with each parent's matrix in order up the tree to the root.

For example, this snake has a first body segment 1004, a second body segment 1005 and a third body segment 1006 which are rotated relative to the segment to which they are attached. The first segment 1004 is attached to the head 1001 of the snake, and its transformation is made relative to the coordinate system of its parent, the snake head. A fixed pivot position is defined relative to the head's coordinate system and all rotations are made as if that point is the origin.

Similarly, the second segment's 1005 transformation is made relative to the coordinate system of the transformed first segment, and the third segment's 1006 transformation is made relative to the coordinate system of the transformed second segment 1005.

Other types of transformations may also be hierarchical, such as deforming transformations. For example a deformation of a parent mark along a curve may also deform child marks of that parent.

Thus, the variation introduced to the snake's head and body based on its marks relative transformations enable notable effects of mark parameters within the larger element, and enable uniform scanning across those swatches.

### Statistical Distributions of Mark Parameters

Recall from numerous locations of the '013 application (especially paragraph [0107] thereof) that the mark parameters are created by an encoder and have continuous values represented as real numbers. As the encoder does encode only a finite number of bits and hence a finite number of data records, there will be only a finite number of states for each mark parameter, but a defining features of imperfect patterns is that number of potential states of each mark is quite large, occupying a virtual continuum of the range specified by the designer of the imperfect pattern.

The statistical distribution of the mark parameters of imperfect patterns tend to be somewhat uniform when a mark may easily be observed, as having many diverse states allows for the most data communication. When the effects of mark parameters become harder to discern, for example if the mark is small, or faint, or obscured, then one could imagine situations where it is best to simply use extremes of the predefined ranges as that is all that may be discernible.

Thus, the natural distribution of mark parameters typically lies between a uniform and bimodal distribution of values. The distribution may also be affected by numerical side effects of the interaction between the encoder and decoder models during training. For example, a transformer machine learning model used as a decoder may cause the encoder to produce a more bimodal distribution of mark parameters than when a convolutional machine learning model is used as a decoder in training.

The statistical distribution of the mark parameters does affect the aesthetics of the imperfect pattern, and the emotional framing of the article that the imperfect pattern is attached to. As such, it may be useful (for instance, to match a predefined aesthetic, to create a customer preference, or to cause a person to perform an action) to prescribe a desired statistical distribution for each mark parameter in the pattern template.

The '013 application describes in numerous locations (especially FIG. 8 thereof) a training process which simultaneously develops an encoder model and decoder model by calculation of a loss value and a gradient of the loss which is used by an optimizer to update the parameters of the models. Recall that FIG. 4 of the present application depicts the addition of optional components into the loss value, including calculation 410 of distribution loss 405 which may be summed into the loss value 404.

Distribution loss may be calculated during the training process by examining the distribution of values for each mark parameter in each batch of training images. Let's say that an artist, seeking to represent a predefined aesthetic to achieve a functional purpose, in addition to choosing the range of a certain transformation and the limits of that transformation also sets a desired statistical distribution of the mark parameters when associated with random payload.

Such a distribution could be expressed qualitatively, such as by a uniform distribution, or bimodal distribution, but the distribution may also be expressed quantitatively, for example, by a standard deviation from the center. In a preferred embodiment, a quantitative representation of predefined distribution may be a histogram of values spread across the predefined limits of the transformation.

As a concrete example, let's say that each training batch has 128 training images, each showing an imperfect pattern associated with a random data record. And let's assume that one mark has its scale tied to a transformation which might scale it from 90% of original to 110% of original size in the pattern template. We divide that domain into 16 equal width buckets and measure how many instances of the associated mark parameter fall into each bucket (buckets can be jittered to prevent any aliasing resulting from fixed bucket locations).

With 128 samples, if we want a uniform distribution, we would expect 8 samples to fall within each of the 16 buckets. Referring to FIG. 2 of the present application, we may calculate 410 the distribution loss 405 for a single mark, for example, by measuring the norm between the number of samples expected in each bucket of the desired distribution by the predefined distribution and the number of samples actually landing in each corresponding bucket. As with other loss components, we may scale down the distribution loss 405 prior to summing 403 to calculate the total loss value 404.

Of course, this technique works for any predefined distribution, as any distribution may be converted into a histogram which can be measured against the histogram of the actual distribution encountered during training.

An introduction of distribution loss may decrease the achieved accuracy of the pattern, as we are now limiting how the design can be optimally expressed, but statistical distribution is a powerful tool for driving emotional framing, matching a predefined aesthetic, and achieving a functional aesthetic outcome.

### Enabling Applications

A number of solutions are described herein that may extend the functionality and applicability of systems using imperfect patterns.

### Split Payloads

Recall from various embodiments of the '013 application that an imperfect pattern may encode a plurality of data bits, and that the data bits may be divided to different functions. Recall also that an imperfect pattern decoder may output floating point values which may be checked for polarity, for example, and converted to a binary data record. The pattern of bits may be evaluated by an error detection and/or correction module, for example, the Reed-Solomon error correction algorithm which examines the bits to determine if a verified data record may be extracted.

In some applications it may be beneficial to divide the data record payload of the imperfect pattern into multiple sections, each section of the data record independently verifiable. For example, a 128 bit payload may be divided into two 64 bit sections. Each section may have some of the data bits dedicated to error detection and/or correction. For example, each section could have 32 data bits and an additional 32 error correction bits to be analyzed by the Reed-Solomon algorithm. Each section is then verified independently using its own data and error correction bits.

This arrangement provides certain benefits, for example, during an interactive scan we wish to overlay an augmented reality overlay or highlighting of the pixels contributing to the scan, even if the entire data record cannot be read. Giving the user visual feedback in this form may inform the user or facilitate adjustment of scanning procedure.

Alternatively, a first section of the data record may comprise identifying information, and a second portion may comprise auxiliary information to an article. For example, on a carton of milk, a first portion of the data record may identify the product to the supermarket, a second section include auxiliary data such as information on the source, allergens, expiration date, or processing of the product. In circumstances where for some reason the second section of a pattern on a milk carton cannot be read, one can still process the carton at checkout if the first section may be successfully read.

### Support Queries

Add refutes output
Add Center of pattern output from decoder.
   Put text or crosshair on output location
verifying a code (reducing false positives)
Cross-Checking Code Integrity Across Multiple Views
   If a product is captured from multiple angles, the neural network could help verify consistency across views and ensure the integrity of the code remains intact across those perspectives.

Recall that a decoder may be co-trained with an encoder, and during the training that a swatch of imperfect pattern, comprising an arbitrarily shaped portion of pattern, may be processed by the decoder. By this training, the decoder becomes capable of decoding arbitrary swatches of imperfect pattern of portion sizes similar to (for example, as a percentage) or larger than the swatch size used in training.

An image, or a portion of an image may contain a smaller swatch of imperfect pattern, insufficient in size to enable recovery of a data record. However, with a small amount of pattern, it may still be possible to determine whether the portion(s) of a pattern are consistent with, or “support”, a specific data record. Additionally, it may be possible to determine that a swatch of imperfect pattern is not consistent with, or “refutes” a data record. Either of these tests may enable a great many features in the use of imperfect patterns.

For example, when a user successfully scans an imperfect pattern with a camera and extracts its data record, we may wish to visually identify the pattern by displaying the pattern with augmentation highlighting what was scanned. To facilitate this, we may wish to pass portions of the scanned image (for example, gridded portions, or portions generated by a rolling window) through such a test to see if the portion of image supports the data record.

Alternatively, an image may contain two variations of an imperfect pattern, each encoding a different data record but sharing the same visual style and potentially overlapping in space. Recall that imperfect patterns may repeat and have no visual beginning or end. Because semantic segmentation techniques may identify all regions of both patterns as being one segment, and instance segmentation may have difficulty differentiating between the two overlapping patterns, it can become a challenge to identify where one imperfect pattern ends and the other begins.

We may also want to detect the spatial bounds of the article based on its pattern, or recognize that an additional pattern is present and has not been scanned. Each of these features may be enabled through identifying the portions of the image that support or refute a scanned data record.

While scanning may more typically comprise the action of identifying the encoded data record(s) present in an image, scanning may also comprise the action of searching for a specific code. For example, we wish to locate an object displaying a specific imperfect pattern (associated with a specific data record).

As an example, a warehouse contains a specific box we are searching for that is identified by a specific data record. The box displays an imperfect pattern encoding the data record, but the warehouse also contains a large number of boxes displaying imperfect patterns encoding different data records in a warehouse. Cameras placed around the warehouse track the location of boxes by scanning their imperfect patterns in the camera images, or in subregions of the camera images. A worker uses a computer to attempt to locate the box, however, its imperfect pattern cannot be decoded from images available from any of the camera views.

Perhaps the box is obscured by other boxes, hiding most of it from view, or perhaps large portions of the imperfect pattern has been damaged (for example, by a forklift), or the box is covered by a workers vest, however small portions of imperfect pattern we seek may still be visible.

Instead of using a decoder to find a camera image (or potentially a subregion of a camera image) that decodes to the specific data record we seek, we instead process those images or subregions by a module capable of performing a “Support Query” which tells is whether an image contains pattern consistent with the specific data record, this test may identify areas to further search, for example, by alerting a worker to go to those possible locations for the pattern we seek, where they may more closely inspect or remove obstacles blocking view of the pattern.

Additionally, a user might perform a Refute Query, on such images or image subregions to identify locations where there is no evidence that the specific data record may be encoded, and there is evidence of a different data record being encoded. Such a query would allow a worker to know, for instance, where not to search for the imperfect pattern conveying the specific data record.

When searching for the object, the worker may hold an augmented camera display, which overlays on the display guidance to the worker for where to search more closely. Augmentation highlighting regions of the display corresponding with where the imperfect pattern encoding the specific data record may be located may be generated by such a support query.

In each of these examples, the support query comprises a test for consistency of an image containing a “micro-swatch” (a swatch of pattern containing too small a portion of pattern for a full identification) with a specific data record.

Recall that co-training may be performed on swatches of pattern, and that the encoder and decoder may learn to represent the data record in, and extract the data record from, just a swatch of the pattern. A portion of pattern smaller than the training swatch size may be considered a micro-swatch. The micro-swatch, for example, may comprise just a few graphic elements of the pattern, and like a partial fingerprint, while relationship or interaction of these graphic elements are insufficient to fully identify the data record, we may still evaluate whether the arrangement of graphics elements supports or refutes the presence of the specific data record.

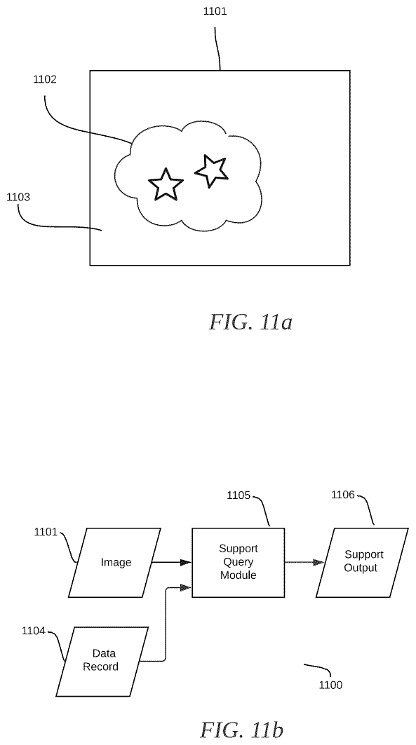

FIG. 11A of the present application depicts an image 1101 comprising a micro-swatch 1102 of imperfect pattern derived from a specific data record but too small an area to allow for decoding the data record. The image may also comprise a background 1103 not comprising the imperfect pattern or which may comprise imperfect patterns encoding data records different from the specific data record.

FIG. 11B of the present application depicts an embodiment of a system 1100 capable of making a support query. An image 1101 and a data record 1104 are fed as inputs to a support query module 1105. The support query module 1105 then outputs a support output 1106 which indicates the degree of support for the data record between the micro-swatch of pattern 1102 and the data record 1104.

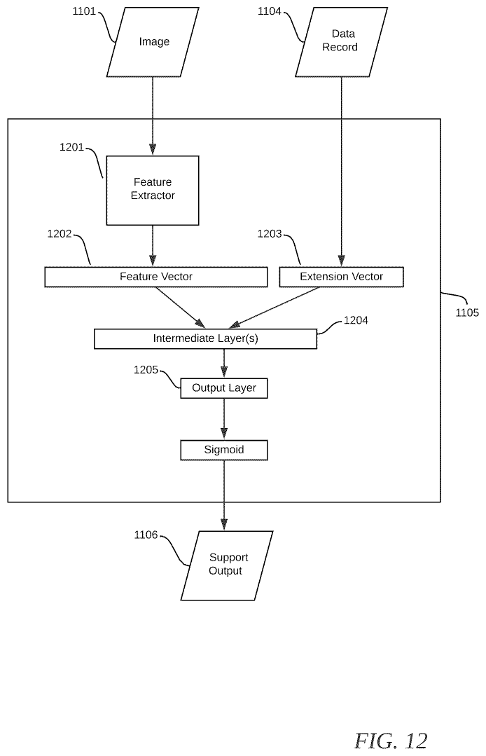

The support query module may, for example, comprise a trained machine learning model, for example, a model with an architecture depicted in FIG. 12 of the present application.

The support query module 1105 may comprise a machine learning model comprising a number of components. A feature extractor 1201, such as a convolutional network or a residual network (e.g. resnet34), produces a feature vector 1202. For example, the length of the feature vector may be 256 elements.

The feature vector is appended with an extension vector 1203 which comprises the data record to search for, thus the extension vector should contain the same number of elements as the bits of the data record (e.g. 48 bits, 96 bits, or 128 bits). The extended feature vector is then fully connected to a series of one or more intermediate layers, wherein each layer is fully connected to its successor and wherein an activation function is performed in generating each layer. The intermediate layers may comprise 128 elements each, for example.

Following the last layer of the intermediate layers is an output layer 1205 which comprises just one element. This element may be a real value, that may, for example, be put through a sigmoid function that reduces the range of the output 1106 to values between zero (indicating no support for the data record 1104) and one (indicating strong support for the data record 1104), with values in-between indicating a degree of confidence in consistency.

An image 1101, for example, a raster image having a resolution of 224×224 may be passed as input to the Feature Extractor 1201, and the data record 1104 we seek to query support for may be passed into the extension vector 1203. When the various layers of the support query 1105 have processed into the output layer 1205, the output layer may be processed by a sigmoid function 1206 and returned as the support query module output 1101.

### Training a Support Query Module

The support query module may be trained using supervised, semi-supervised, or self-supervised learning techniques to determine whether an image, or a portion of an image, contains imperfect pattern content that is consistent with a specified data record. In certain embodiments, training is performed using examples comprising images or image portions paired with corresponding data records and labeled according to whether the image portion supports, refutes, or is neutral with respect to the data record.

Training data may be generated by rendering imperfect patterns encoding known data records and extracting swatches of varying sizes, shapes, and locations from the rendered patterns. Swatches used for training may include swatches large enough to permit full decoding of the data record, as well as smaller swatches that are insufficient for decoding but that nonetheless contain partial information indicative of the encoded data record. Swatches smaller than the swatch size used for decoder training may be designated as micro-swatches for purposes of training the support query module.

In some embodiments, positive training examples are formed by pairing a micro-swatch extracted from an imperfect pattern with the data record that was encoded into that pattern. Negative training examples may be formed by pairing the same micro-swatch with a different data record, or by pairing a micro-swatch extracted from a different imperfect pattern with an unrelated data record. Additional negative examples may include image portions containing background content, noise, occlusions, or imperfect patterns encoding other data records. In this manner, the support query module is trained to discriminate between image portions that are consistent with a given data record and those that are inconsistent with that data record.

Training images or swatches may further be augmented to simulate anticipated image degradation or capture conditions. Such augmentation may include, by way of example, changes in resolution, blur, noise, compression artifacts, lighting variation, partial occlusion, geometric distortion, or combinations thereof. This augmentation allows the support query module to learn robustness to the same types of degradation expected in deployment environments.

In certain embodiments, the support query module is trained independently of the decoder used to recover data records from full or partial imperfect patterns. In other embodiments, the support query module shares one or more components with the decoder, such as a feature extractor or intermediate representation, and may be trained jointly or sequentially with the decoder. For example, a feature extractor trained for decoding imperfect patterns may be reused and fine-tuned as part of the support query module, while additional layers are trained to evaluate consistency between extracted features and a candidate data record.

The training objective may comprise minimizing a loss function that penalizes incorrect classification of support or refutation. For example, the output of the support query module may be trained to approximate a probability or confidence value indicating consistency between the image portion and the data record, and a binary cross-entropy, logistic, or similar loss function may be applied. In some embodiments, training may also incorporate margin-based losses or ranking losses to encourage stronger separation between supporting and refuting examples.

In certain implementations, training may further include examples in which multiple imperfect patterns overlap spatially within the same image, each encoding a different data record. In such cases, micro-swatches extracted from overlapping regions may be labeled according to which data record they support or refute. This allows the support query module to learn to evaluate consistency even when multiple patterns are present or when semantic or instance segmentation techniques are insufficient to separate them.

Once trained, the support query module may be applied to an entire image or to multiple subregions of an image, such as regions defined by a grid, sliding window, or region proposal mechanism. The outputs of the support query module may then be used to generate spatial maps indicating regions that support or refute a specified data record, to guide further scanning, decoding, user interaction, or physical inspection of the associated article.

### Locating a Pattern in an Image

There are many ways that an imperfect pattern may be located in an image. For example, the location may be represented as a center of the pattern in the two-dimensional space of the image. Such a location may be used, for example, to augment a display with a marker showing where the pattern is located, or may be used to place text over an imperfect pattern in an image.

In one embodiment, an extension of the training process described in the '013 application, a decoder may be modified to output, in addition to the payload vector, a locating vector indicating where in the image to find the center of the imperfect pattern. The pattern center, for example, may be expressed as a coordinate pair in a coordinate system of the image.

Such a decoder may be trained, for example, with a loss function that not only has a component for the accuracy for the decoding, but also has a component for the accuracy of the pattern center.

In another embodiment, a pixel mask, corresponding to the locations of the imperfect pattern, is extracted from the image. A number of methods of extraction may be used, for example any of the methods detailed in the various subsections of “Identifying Pixels Contributing to Decoding” may be used to generate a suitable pixel mask. We may then find the center-of-mass of the pixels in the mask that signify the presence of the imperfect pattern and use the center-of-mass as our locating vector.

Such a coordinate pair may be used to augment the image. Augmentation may comprise text, icons, two-dimensional graphics, or three dimensional objects, superimposed on top of the image and located in the image based on the pattern center coordinate pair.

A capture system capturing the image may have a known projection model and intrinsic parameters. For example, a camera may have a pinhole camera model, a known focal length, and a known principal point of projection. Thus using this model, we know how to project 3D points in the field-of-view of the camera, but we also know what three-dimensional ray corresponds to any two-dimensional point on the image.

Having the camera's extrinsic parameters, such as its location and orientation in predefined space allows us to transform a ray, such as a ray derived from an image point, into the predefined space. For example, we may know the camera's position and orientation relative to a geodetic coordinate system, and thus can transform the ray into that coordinate system, or may know the camera's position and orientation relative to a cartesian coordinate system, such as 3D coordinate system used to map a local space, such as a building, a city, or a countertop,

Thus, the location of a pattern in an image may be transformed into a three-dimensional ray in a local or global space. The ray may be intersected with known boundaries, such as walls, floors, or physical objects to find a 3D point correlated with the pattern center. Alternatively, the ray may be combined with a distance value, for example, a distance derived from a range finding mechanism on the camera (such as sonar, LIDAR, or stereovision based range-finding), or a distance derived from visual queues of the object or its markings, to produce a 3D point the specified distance along the ray.

In another embodiment, multiple cameras, each with known extrinsic and intrinsic parameters cover a physical space. As an example, a product displaying an imperfect pattern is located by multiple cameras at a checkout counter. The imperfect pattern not only identifies the product, but also aids in our location of the product on the counter. A plurality of cameras with known intrinsic and extrinsic parameters may each capture an image of the product. When decoded, each image provides a redundant identification, but also provides a locating vector within the respective image. By use of the intrinsic and extrinsic camera parameters, we may translate each of these locating vectors into a 3D ray in the common space of the checkout counter. We may then find the intersection, or point of nearest crossing of the plurality of rays, this point indicating a 3D location of the product in the space of the checkout counter.

In yet another embodiment, we may not know the intrinsic and extrinsic parameters of cameras capturing images of imperfect patterns. A plurality of cameras with unknown position, orientation or projection may capture images of their surroundings which include a plurality of different imperfect patterns. As an example, a fleet of vehicles, aircraft, equipment and persons each having one or more affixed cameras and each displaying a different imperfect pattern on their surface or clothing is deployed in an area. A set of images may be captured simultaneously from a plurality of cameras in the fleet, which may then be decoded locally to identify and locate the imperfect patterns, or may be transmitted to a server to perform the decoding.

A computer, receiving all the identifications and corresponding locating vectors may perform a bundle adjustment on the images to derive the extrinsic parameters for each camera, locating each asset of the fleet in relation to each other. If a plurality of the assets have a known position in a fixed coordinate system, for example, having a surveyed position or a position derived from a GPS transmission, those assets may be used to transform the relative locations derived from the bundle adjustment to the coordinate frame of the fixed coordinate system by pinning known locations to that fixed system.

### Identifying Pixels Contributing to Decoding

One approach to this challenge is to identify the pixels of the image that most contribute to generating the payload vector output of the decoder module. Recall that the decoder module may comprise a machine learning model having inputs of the pixels of an image and having outputs of the recovered data record. Upon successful retrieval of a data record (as verified by the error detection and correction module, or a confidence output of the neural network), we may use gradient based methods to identify the pixels most contributing to the result.

For example, a saliency map may be calculated as the gradient of the output with respect to the input image. The magnitude of each pixel's gradient can be used to create the saliency map and the map can be used to augment an image. Augmentation may appear, for example, as color overlayed on top of the captured image when previewed in the scanning app. Alternatively the augmentation may enhance or brighten those areas of the input image to show the scanner is focusing on those pixels.

There are many approaches we may use to identify pixels contributing to the output include Grad-CAM (Gradient-weighted Class Activation Mapping), which compute gradients of the output with respect to the feature maps of a specific convolutional layer and weight the feature maps by summing the computed gradients, Integrated Gradients, which compute the integral of gradients as you interpolate between a baseline image (such as a black image) and the input, or IME (Local Interpretable Model-agnostic Explanations), which perturbs portions of the input by modifying or occluding pixels in a local region to test its contribution.

In another embodiment, pixel contribution may be estimated using a sliding window approach. In such an approach, the decoder processes a series of subregions of the image, for example windows of fixed or varying size scanned across the image. Regions whose inclusion or exclusion substantially affects decoding success, confidence, or payload recovery may be inferred to contribute to decoding. The results of sliding window analysis may be accumulated to form a spatial map indicating regions of importance.

### Image Segmentation Methods

In certain embodiments, image segmentation techniques are used to assist in identifying pixels or regions contributing to decoding. Segmentation may be used to partition an image into regions corresponding to candidate objects, surfaces, or pattern instances prior to or in conjunction with decoding. For example, semantic segmentation may be used to classify pixels into foreground and background regions, or into categories such as packaging, apparel, or surface areas likely to contain imperfect patterns. Instance segmentation may be used to isolate individual articles or pattern instances when multiple objects are present in a scene.

Segmented regions may be processed independently by a decoder or support query module, and the results of decoding or support determination may be associated back to the segmented regions. In this manner, segmentation can reduce ambiguity in multi-object scenes and provide spatial context for pixel contribution analysis. Segmentation outputs may also be combined with gradient-based attribution maps to restrict attention to pixels within regions deemed relevant by the segmentation process.

### Occlusion Methods

Occlusion-based techniques may also be used to identify pixels or regions contributing to decoding. In such methods, portions of the image are selectively masked, blurred, or otherwise modified, and the effect of the modification on decoder output is observed. If occluding a particular region significantly reduces decoding confidence or prevents recovery of the data record, that region may be inferred to contribute to decoding.

Occlusion may be applied at different spatial scales, ranging from individual pixels to larger contiguous regions. Multiple occlusion patterns may be evaluated, and the resulting changes in decoder output may be aggregated to form a spatial contribution map. Occlusion methods may be applied alone or in combination with other techniques, such as segmentation or gradient-based attribution, to refine identification of contributing regions.

### Gradient-Based Methods

Gradient-based methods may be applied not only at the input image level but also at intermediate representations within the decoder. For example, gradients of decoder outputs with respect to intermediate feature representations may be used to identify which learned features and corresponding spatial regions are most relevant to decoding. Such methods may be particularly useful when the decoder comprises deep neural networks with hierarchical feature representations.

In some embodiments, gradient-based attribution may be conditioned on specific outputs, such as individual payload bits, confidence scores, or support query outputs. This allows the system to distinguish regions contributing to different aspects of decoding, such as identification versus verification, or support versus refutation of a data record.

### Combining Methods

In practice, multiple attribution and localization methods may be combined to improve robustness and interpretability. For example, a system may first apply semantic or instance segmentation to identify candidate regions, and then apply occlusion or gradient-based methods within those regions to identify finer-grained pixel contributions. Alternatively, gradient-based saliency maps may be used to guide the selection of regions for occlusion testing, reducing computational cost.

The outputs of different methods may be fused, for example by averaging, weighting, or thresholding, to generate a consolidated contribution map. Such combined approaches may provide more stable and interpretable results than any single method alone, particularly in complex scenes with noise, occlusion, or multiple overlapping imperfect patterns.

### Spatially Locating Articles

Information derived from pixel contribution analysis may also be used to spatially locate articles displaying imperfect patterns. For example, a contribution map may be used to estimate the center, extent, or orientation of a pattern within the image. This information may be combined with camera parameters, such as field of view, projection model, or depth estimates, to infer the spatial location of the article relative to the camera.

In some embodiments, spatial location may be estimated based on the portion of the camera's view frustum occupied by contributing pixels, or based on distance cues derived from image scale, focus, stereo disparity, or range-finding sensors. Such spatial localization may be used to guide user interaction, position augmented reality overlays, or assist robotic or automated systems in interacting with the article.

### 3D Registration of Imperfect Patterns

A detected imperfect pattern may trigger other types of augmentations, for example, an augmented reality 3D graphic overlay may be visualized on top of the imperfect pattern. Rendering of the augmented reality graphics may be accomplished by a real time 3D rendering and compositing system which renders 3D content in a coordinate system relative to the detected pattern.

A coordinate system relative to the imperfect pattern may be established in a few ways. One approach is similar to that taken in US patent publication number US 2021/0124969 in which a neural network outputs pose values it estimates for the pattern. The encoder in this arrangement additional outputs corresponding to the pose values (e.g. six degrees of freedom placing the 3D object), and the training requires the addition of a loss component that measures the difference between the actual pose of the pattern relative to the camera and the pose estimated by the decoder.

An alternative approach is to identify salient points captured in the images. Such points may be located with an algorithm such as the SIFT (Scale-Invariant Feature Transform) algorithm, which selects pixels from the input image having certain properties. Once a successful detection is made by the decoder and we know the associated data record, we can use the pattern template to render a model version of the data record into a constructed 2D image. The constructed 2D image may also be processed to recover salient points, and a mapping may be made, for example by using FLANN (Fast Library for Approximate Nearest Neighbors) or Brute Force Matcher to map associate points between the constructed image and captured image. A transformation matrix may then be calculated between the sets of points, and the transformation matrix may be used to render the augmented reality content.

### Extracting Pose of Articles

In a preferred embodiment, the placement of an imperfect pattern on a 3D article, such as a product package, is known in advance. For example, each version of the product may have a different imperfect pattern applied, but applied in the same place on the article. This relative placement of the pattern relative to the article may be described, for example as a 4×4 3D transformation matrix.

With knowledge of the relative placement of the pattern, we can work backwards from the pose of the imperfect pattern to find the pose of the article displaying it, for example by multiplying the relative pose placement matrix with the imperfect pattern pose matrix. We may then render augmentation on top of the article itself, for example, we can outline the silhouette of the article, or highlight, outline, or otherwise draw attention to specific areas of the packaging.

The 3D pose of an article displaying an imperfect pattern may also be used for other purposes, for example for a machine to pick up the article, to navigate an area with articles displaying imperfect patterns by using the patterns as landmarks.

### Detecting Multiple Imperfect Patterns

In some applications, for example, in the workflow of a conventional self-checkout counter, a user (such as a customer) may scan each item sequentially. In numerous locations of the '013 application, a system is described that decodes an image of a single imperfect pattern (In some embodiments, the decoder may decode a swatch comprising one or more incomplete portions of a pattern, the pattern may be decoded from a curved surface, shot at arbitrary vantage points, or be partially obscured or marred.)

In the application of imperfect patterns to checking inventory, a user may sequentially scan each box of a stack of boxes in order to gain information, or register information such as tracking or item status (loaded, shipped, returned, etc.).

In both of these example applications as well as numerous other applications, the actions could be performed by users (or automated systems) much more quickly if multiple imperfect patterns could be scanned from a single image.

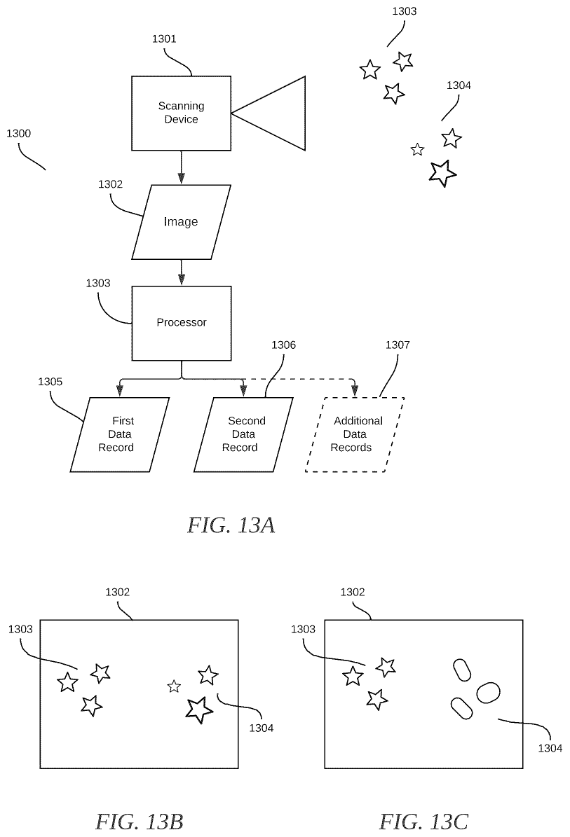

FIG. 13A of the present application depicts a system 1300 that decodes multiple imperfect patterns captured in a single image. A scanning device 1301, which may comprise a digital camera, captures an image 1302 comprising multiple imperfect patterns, as illustrated by a first imperfect pattern 1303 a second imperfect pattern 1304.

As depicted in the image 1302 of FIG. 13B of the present application, the image may comprise swatches of imperfect patterns generated from the same pattern template, or may, as depicted in FIG. 13C of the present application, comprise swatches of imperfect patterns generated from distinct pattern templates.

The imperfect patterns may be displayed on separate articles, or multiple imperfect patterns may be displayed on the same article.

A processor, configured as a combination of hardware and/or software, performs an analysis of the image 1302 and produces a first data record 1305, extracted from the first imperfect pattern 1303, and a second data record 1306, extracted from the second imperfect pattern 1304.

Such a system may decode additional imperfect patterns yielding additional data records 1307, as the methods described for embodiments of the processor 1303 may each be expanded to decode multiple data records.

### Visual Feedback of Scanning

It is often helpful to give visual feedback when scanning. For example, when scanning a QR code, many QR readers will locate the QR in the image and highlight the region of the image (for example with a box or containing the QR. Once located, the highlighting of the code may serve to indicate that a code is present, or which code, if multiple are present, is being decoded.

Similarly a system to highlight the location of imperfect patterns in an image would be useful to show users what they are scanning, whether the scan is successful or only partially successful (for example, in order to encourage a user.) As an imperfect pattern has no locating devices, nor any elements common to all possible variation of aesthetic traits with which a data record may be encoded, and because an imperfect pattern may repeat seamlessly across a surface, having no clear beginning or end, the task of showing the location within an image of the object or pattern being scanned presents a significant challenge.

Depicting What is being Scanned (Visual Indicator)

In certain embodiments, the system is configured to indicate to a user which portions of an image or scene are being scanned, evaluated, or considered relevant by the system. Such indications may be provided to improve user understanding, guide scanning behavior, or increase confidence in the scanning process.

The indication may be generated based on outputs of a decoder, a support query module, or a combination thereof, and may correspond to image regions that support a data record, are candidates for decoding, or are currently under analysis. In some embodiments, the system generates visual augmentation that emphasizes such regions relative to other portions of the image.

For example, regions of interest may be visually distinguished by outlining or glowing boundaries, highlighting or brightening selected areas, or darkening, blurring, or otherwise deemphasizing regions not currently relevant. In some embodiments, a bounding shape, such as a box or contour, is rendered around a region being scanned. In other embodiments, one or more indicators, icons, or markers are displayed in proximity to or overlaid upon the region of interest.

The form, intensity, and duration of the indication may vary dynamically based on scanning state, confidence levels, or user interaction. For example, a region may be indicated differently when it partially supports a data record than when it supports a data record with high confidence or has been fully decoded.

Such indications may be rendered in real time on a live camera display or applied to stored images, and may be combined with other feedback mechanisms to assist the user in understanding which portions of the scene are contributing to scanning, decoding, or support determination.

### Visual Feedback on Rigid Objects

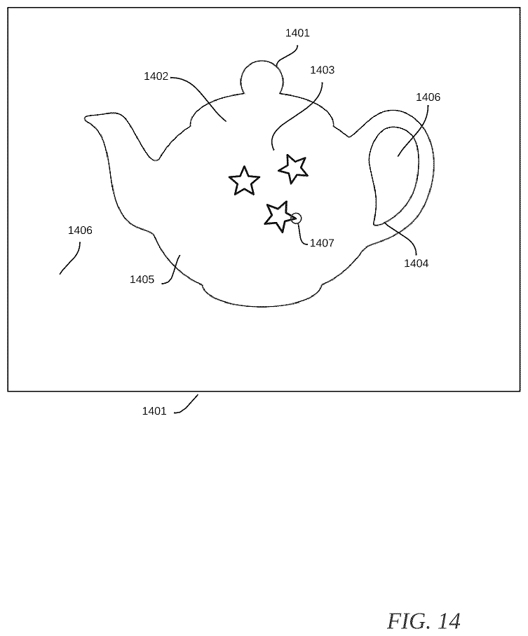

FIG. 14 of the present application depicts an image 1401 of a rigid object 1402 (in this example a teapot) displaying an imperfect pattern 1403 (in this example being comprised of stars). An outline 1404, or silhouette of the object divides the image into one or more interior regions #F05 and one or more exterior regions 1406. (Note in this example, that inside the teapot handle is an exterior region 1406 inside the interior region of the whole object silhouette 1405.)

Visual feedback may be presented, for example overlaid atop of, or by modifying the captured image to draw user attention to the pattern or object being scanned. This is an essential part of certain work flows, such as scanning of each object of a set of objects. In such a task, knowledge that the object the user is attempting to scan is the very same object that the scanner picked up may be essential. Providing visual cues (in the form overlaid on top of video, or displayed with augmented reality technology such as graphic augmented glasses or displays) allows users to quickly and silently ascertain that knowledge.

In some applications, a user may wish to scan multiple articles simultaneously from a single captured image, or from a set of images of the articles. As one example, instead of sliding individual items across a scanner, a supermarket customer may simply bring up their basket and place it on the counter. A camera may capture an image of the contents of the basket, the image then processed by a computer to identify the objects in the basket. Such processing may occur, for example, by utilizing an instance segmentation module (such as Mask R-CNN, YOLACT, or Detectron2) to create a separate pixel mask (or region, such as bounding box) for each object visible in the basket.

Each region or mask may then be processed by identifying module, which may identify the goods based on one or more techniques including barcode, qr or digital watermark reading, optical character recognition, image classification models (including machine learning models), or imperfect pattern decoding.

A piece of produce, an apple for example, may be identified by a machine learning classifier. The weight of the apple, or variety, organicness, etc., of the apple may be encoded in an imperfect pattern applied to a sticker or imprinted on the apple. The imperfect pattern may be decoded to identify the apple and the decoded weight may be used to price the apple.

A box of cereal may be decoded based on text recognition of words on the front of the box, or by the UPC code on one corner of the box, or by image recognition of the graphic design, or by recognition of a digital watermark or data encoding pattern (such as an imperfect pattern) displayed on other parts of the packaging.

Each segmented instance is analyzed by one or more techniques and if any of the techniques produce an identification, we may deem that segment identified. If all segments are identified, then each may be rung up and displayed to the customer along with a total cost. Such display may occur on a traditional display screen in text or graphical form. Alternatively, we may see an image of the basket with a price annotation displayed atop each item, or visually attached to each item via a line or curve.

Perhaps not all items in the basket may be directly visible by the scanner. For example, the customer may have a basket full of goods, some goods on top of other goods obscured from view by the scanner. A bag of potatoes, for example, may hide a package or razor blades underneath it. Detecting such situations and guiding customers to resolve them may be essential to loss prevention.

### Use Cases of Visual Indicators

In certain use cases, visual indicators are employed to assist a user in locating a specific article among many visually similar articles. For example, when scanning a wall or array of boxes, each displaying an imperfect pattern encoding a different data record, the system may perform support queries for a selected data record across images or image subregions corresponding to the boxes. Based on the resulting support outputs, the system may generate visual indicators highlighting one or more boxes that exhibit support for the selected data record, while deemphasizing boxes that refute the data record. Such indicators may include outlines, glows, shading, bounding shapes, or other augmentations rendered on a display associated with a camera view. As the user moves or reorients the camera, the indicators may update dynamically, guiding the user toward the box of interest even when the imperfect pattern is only partially visible, obscured, or captured at an angle.

### Security Features of Imperfect Patterns

An imperfect pattern may contain security features which make it difficult to counterfeit. For example, the graphic elements that make up the pattern may emit colors that are not visible to the human eye. A decoder is trained, for example, by a co-training process such as described in numerous locations in the '013 application (especially FIG. 8 thereof). Note that the training image renderer which feeds the decoder typically generates an RGB image, having just three color channels or samples. These channels could be spread out farther on the spectrum to include the infrared, ultraviolet, or frequencies beyond this range, or the samples could be moved outside the visible range altogether. Additionally the training image renderer may render a larger number of spectral samples, for example 6 channels that can define a wider range of colors making the pattern more difficult to fake.

A complementary camera system, having a matching set of color channels or samples is used for scanning applications using the trained decoder. The camera system, for example, could be attached to a point of sale system, or a checkout counter scanner, which could verify the articles authenticity by ensuring not only that the data record extracted from the articles is correct, but also that hyperspectral colors used in the artwork also match the expected colors.

Such matching could be done as part of the training process of the decoder. Recall from numerous embodiments of the '013 application (especially paragraph thereof) that the training images are processed to adjust for color based on differences in lighting, camera systems, and other environmental factors. This ensures robust detection. This training process could be modified to adjust for only the reasonable adjustments in color that could not be attributed to a fake imperfect pattern.

An additional forgery output could be created for the decoder module. The module could be trained as with a typical co-training process, for example, but with an additional loss component we may call “forgery” loss which can be added to the total loss. The training process is modified to insert “forged” imperfect patterns having incorrect hyper spectral colors into training batches. The images, as with all other images of the batch, go through individual image degradations that yield robustness, but are also limited to the chromatic changes that can reasonably be expected in our targeted environment. The forgery loss is calculated for each image by comparing the forgery output of the decoder module to a value representing the real/forged status of the training image. Thus, the decoder may signal to the user that the article is authentic or is a forgery.

Alternatively, an imperfect pattern may contain holographic materials or inks that change color or show a graphic based on direction of illumination. As with the prior example, the training process can be modified to simulate the holographic materials used in a graphic element, for example, by simulating directional lighting from one or more sources, wherein a direction vector from the ray intersection point to the light is calculated, and compared with the surface normal to determine a direction specific color. Thus the decoder may be trained, in a typical RGB color space, or extended or hyper spectral space, to recognize patterns with the holograph. As with the previous example, incorrect (forged) holographs could be inserted into the training process and used to train a forgery output for the module. The holographs present in the imperfect pattern may also be used by store employees, for example, for a quick human check for authenticity.

As another example, the imperfect pattern may be generated with elements using anisotropic reflectors which responds differently based the polarization of light striking the surface, and these materials may be simulated in training to match the polarization of a system of one or more cameras which scan articles displaying imperfect patterns illuminated by polarized light.

The data record may also be encrypted, for example, with a one-way or hash algorithm, with a public key encryption system, or with a symmetric key system like DES, preventing access to those without the security key.

In some embodiments, the imperfect pattern may change its configuration periodically, for example, if the imperfect pattern is shown on an electronic display. Making the data record, and resulting imperfect pattern, a time based configuration can limit the time that a pattern may be exploited by copying.

Data records may also contain derivatives of or links to biometric data in order to identify a person who is authorized to use the article displaying the imperfect pattern.

Imperfect patterns may also include or be used in conjunction with other security devices such as RFID, NFC and magnetic ink data encodings.

These techniques may be used in any combination to provide enhanced security functions for articles bearing imperfect patterns.

### Access Systems and Time Sensitive Data

Access systems, for example, systems which may allow users to login to computers, network accounts or services, or to gain entry to facilities, or to limit actions to authorized personnel may also employ imperfect patterns not simply to convey information but also to achieve functional aesthetic purposes such as establishing trust with a user, identifying or reinforcing the brand image of the organization that is granting access, or creating a user experience that users rate as enjoyable.

Consumers make decisions in the purchase of products or subscriptions that are influenced by their perception of the brand image, the trust they place in the brand, and personal resonance they have with the brand. Use of imperfect patterns as part of a security policy not only allow the conveyance of access-related data visually (decreasing user friction associated with other data conveyance methods) and, as described in paragraphs [0069]-[0070] of the '013 application, encryption of the conveyed data through a non-public encryption method, but also allow the advancement of functions based on the aesthetic of the pattern.

Let's examine some access systems, and how multi-factor authentication as well as other functional goals may be achieved.

In one application, a user possesses a device such as a cell phone or a computerized ID badge which is capable of displaying an animating imperfect pattern. The device may itself provide a factor of authentication in that the user possesses the device (something you have). Additionally, the device may include one or more biometric sensors, such as fingerprint scanner, face identification, or retinal scanner, and use of the device may require such biometric authentication, or use the biometric information to form the conveyed information, thus providing a second form of authentication, biometric (something you are). The device may also require the user to enter a secret code, such as a password or personal identification number (PIN code) which only the user is aware of, thus providing a code based means of authentication (something you know) or any other form of knowledge-based authentication. In combination, these mechanisms may provide a multi-factor authentication system which can be exceedingly difficult for bad agents to penetrate.

The imperfect pattern displayed on the device may, for example, convey an encrypted temporary one time password which changes at rapid intervals (for example every few seconds, or even fractions of a second). The device, which contains a precisely configured clock, potentially synchronized periodically with a clock on a central computer server, creates a data record comprising a plurality of bits. At least some of the bits of the data record are configured to represent the current time interval, for example, they represent a number which changes every second.

Additional bits may be present to convey information that establishes the trusted user's identity. For example, it may contain a security key shared only with a secure server, or may contain a private key of a public key pair. Additional bits may also contain a pin code or password known only by the trusted user or generatable only on the trusted device, or contain biometric data or their derivatives that convey the features of the user's physical form.

The data record may then encrypted with a one-way encryption algorithm, or hash algorithm such as Secure Hash Algorithm (SHA), Message Digest Algorithm 5 (MD5), or Argon2, or by utilizing a private key securely stored on the device, and paired with a public key in a public encryption system, such as Rivest-Shamir-Adleman (RSA) or Elliptic Curve Digital Signature Algorithm (ECDSA), to perform an asymmetric encryption of the full data record. The encrypted data record may then be encoded into an imperfect pattern which animates, or changes, at each time interval.

A scanner, which may comprise a camera connected to a computer, such a personal or work computer, or an electronic circuit connected to an entry system, captures an image of a transient imperfect pattern displayed on the user's authenticating device. The scanner may be connected to a network, which may include other scanners, and may include one or more central servers which control access to a facility, set of controls, or computer or web application.

The scanner may directly decode the imperfect pattern, or may send the imperfect pattern as an image to a central server for the server to decode. Decoding of the imperfect pattern occurs as described in paragraphs [0427]-[0438], wherein the image including the imperfect pattern is converted into a verified data record.

Upon receipt of the verified data record, it is processed by the central server in order to establish the validity of the access request. For example, if the data payload conveyed by the imperfect pattern was encrypted with a one-way or hash algorithm, then on the server the same information source (private key, PIN code, password, biometric info) should be combined with the current time interval to produce a server-side data record, which is then encrypted with an identical one-way algorithm on the server in order to produce a server-side encrypted data record. If the encrypted data record conveyed by the imperfect pattern perfectly matches the server-side encrypted data record, the access is granted, otherwise it is denied.

Alternatively, if the imperfect pattern conveys a data record encrypted via an asymmetric (e.g. public key) encryption system, then the complementary key of the key pair may be used to decrypt the data payload assembled on the user's secure device. The decrypted payload is verified to match the server-side data record comprising the time interval and identifying information.

This scheme provides several compounding security features. First, the encryption provides a secure way to convey the user identity to the server, secondly, the imperfect pattern, comprising a private data encoding schema, provides an additional layer of obfuscation which slows or prevents cryptographic analysis of the data bits.

Even if a bad agent possesses the ability to encode the data into an imperfect pattern, with sufficient number of private identifying bits, guessing the one authenticating data record is impractical. For example if the data record comprises 48 bits, the chances of guessing the correct data record for authentication is less than one in 300 trillion.

In addition to conveying the authenticating data record with additional privacy, an imperfect pattern may also be used to establish trust with a user or to streamline a user interface. For instance, the user awareness of the additional layers of security provided by the privately encoded imperfect pattern contributes to that trust. The imperfect pattern may also be constructed to match a predetermined or recognizable aesthetic that reassures the user that the pattern is authentic to the organization granting access. For example, the imperfect pattern could portray the organization's colors, artwork, logo, or trademark in an imperfect pattern of marks that align with the user's associations with that organization or brand, building familiarity and reinforcing the image of the brand to users of the system.

A system establishing user trust and reinforcing the brand image of the organization enhances the relationship between the user and the system, leading to improved user compliance, and higher levels of customer satisfaction. Let's discuss how we create an imperfect pattern for such a system to achieve those functional goals using process 200 of FIG. 2 of the present application.

First, a designer may identify 201 the aesthetic features that contribute to establishing recognition and trust for the organization granting access. The data payload is also sized 202 to fit an encrypted data record with sufficient length to provide a strong security mechanism. Then, a pattern template is developed 203 to convey the data record in accordance with the defined aesthetic. The pattern template is used to generate 205 an encoder and decoder based on the pattern template and the determined 204 scanning requirements.

Next, the imperfect patterns generated by the encoder are tested 206 to determine how well it establishes trust, conveys organizational identity, or makes the users feel that the system is secure. For example, user responses could be compared in A/B testing in which users are shown two versions of the system, one which the imperfect pattern is a generic pattern not aligned with the organizational branding, or substituted with a legacy code such as a QR, and a second imperfect pattern with aesthetics aligned with the organizational branding. Users may be asked on a measurable scale for each version questions such as if the security system is secure and reliable, how likely they are to trust the system, and how much they identify the imperfect pattern with the organization, and which system they would prefer to use. If a predetermined average trust or associating rating threshold is achieved, the dual-functional aesthetic pattern is deemed complete 207. If not, the predefined aesthetic may be altered 208 based on designer or user feedback to create 203 a modified pattern template that will be used for the next iteration of testing.

Similarly, user responses could be collected for different candidate designs using A/B testing designed to determine how enjoyable or unenjoyable the authentication process is (as measured on a numeric scale). Enjoyability of product use is well understood to contribute to customer satisfaction and loyalty.

### Imperfect Patterns Conveying Temporary One Time Passwords

In today's digital age, secure authentication and verification systems are critical for protecting sensitive information and ensuring the integrity of access control mechanisms. Traditional authentication methods, such as passwords and numeric codes, are increasingly vulnerable to various forms of cyber attacks, including phishing, keylogging, and replay attacks. These methods often rely on static or easily replicable codes, which can be intercepted and misused by malicious actors.

Time-based One-Time Password (TOTP) systems have emerged as a popular solution for enhancing security by providing dynamic, time-sensitive codes that change at regular intervals. These systems typically use a shared secret key and the current time to generate a unique, short-lived code that must be entered by the user to complete the authentication process. However, the reliance on numeric or alphanumeric codes poses limitations in terms of security, usability, and versatility.

To address these limitations, there is a need for an advanced TOTP system that leverages more sophisticated data encoding techniques. Such a system would not only provide enhanced security through dynamic and visually complex patterns but also offer improved usability by leveraging modern technologies such as camera-based scanning and rapid decoding algorithms.

Various embodiments utilize a novel approach to TOTP authentication by utilizing animated data encoding patterns that change every few seconds. These patterns can be displayed on a user's device and decoded by a camera-based system, providing a secure, efficient, and user-friendly means of authentication. The encoding symbology used can vary, including QR codes, barcodes, hidden watermarks, and the innovative imperfect patterns developed in our prior applications.

By augmenting a data record with error correction or parity bits, the encoded pattern can be verified upon extraction, ensuring the integrity and authenticity of the data. This approach not only enhances security but also opens up new possibilities for secure access control in various applications, from cloud services to physical entry systems and event ticketing.

Various embodiments utilize a dynamic, visually secure, and user-friendly solution that leverages advanced data encoding techniques, which may revolutionize authentication systems. This innovative approach addresses the growing need for robust security in an increasingly digital and interconnected world, providing a foundation for more secure and efficient authentication mechanisms.

The authentication system utilizing animated data encoding patterns comprises several key components that work together to provide secure, efficient, and user-friendly authentication. The following is an overview based on the block diagram components illustrated in FIG. 1 of the present application:

The user device (101) may be a smartphone, tablet, or other portable electronic device, equipped with multiple modules to generate, display, and synchronize the animated patterns used for authentication.

The pattern generator (102) may generate unique, dynamic patterns based on a shared secret key and a current time interval. Alternatively, the pattern generator may use a public-private key pair to generate and sign the patterns. These patterns may be visually complex and change every five seconds, enhancing security. The patterns may use QR codes, barcodes, or imperfect patterns.

The pattern display (103) may show the generated patterns on the user's device screen, ready to be scanned by the camera-based decoder at the authentication point. The display may be an LED screen, an OLED screen, or an e-ink display.

The time synchronization module (104) may ensure that the device's clock is accurately synchronized with the authentication server's clock. This synchronization may be achieved using Network Time Protocol (NTP), GPS time synchronization, or manual time setting.

The authentication server (105) may verify the patterns captured and decoded by the camera-based decoder, ensuring secure access control.

The shared secret database (106) may store shared secret keys associated with each user. These keys may be used to generate the expected patterns for verification. Alternatively, the server may store the public keys associated with each user for verifying digital signatures. The database may be implemented using a relational database, a NoSQL database, or an in-memory data store.

The pattern verification module (107) may compare the decoded pattern payload received from the camera-based decoder with the expected pattern generated using the shared secret key and the current time interval. Alternatively, it may verify the digital signature using the user's public key. If they match, authentication is successful. The module may be implemented using a microservice, a monolithic application, or a serverless function.

The time synchronization module (104) may keep the server's clock accurately synchronized with the user devices. This synchronization may be achieved using Network Time Protocol (NTP), GPS time synchronization, or manual time setting.

The camera-based decoder (108) may capture the displayed patterns from the user's device and decode them for verification by the authentication server.

The image capture module (109) may use a camera to capture the pattern displayed on the user's device. The module may ensure that the capture is clear and accurate under varying lighting conditions and angles. The camera may be a smartphone camera, a webcam, or a dedicated scanner.

The pattern decoding module (110) may decode the captured pattern to extract the encoded 24-bit payload. The module may use advanced image processing, machine learning techniques, or traditional decoding algorithms to ensure rapid and accurate decoding.

The error correction module (111) may apply Reed-Solomon error correction to the decoded payload. This ensures the accuracy and integrity of the extracted data despite potential errors during capture. The module may be implemented using hardware, software, or a hybrid approach.

The network communication (112) may facilitate secure communication between the user device, camera-based decoder, and authentication server.

The secure communication channel (113) may ensure that all data transmitted between the components is encrypted and protected against interception and tampering. This channel may support the secure transfer of the decoded payload from the camera-based decoder to the authentication server for verification. The communication channel may use TLS, VPN, or encrypted web sockets.

The system operates as follows. The pattern generator (102) on the user's device generates an animated pattern based on the shared secret key or public-private key pair and current time interval, displaying it on the pattern display (103). The pattern is only displayed when an access request is initiated.

The time synchronization module (104) ensures the user device's clock is synchronized with the time synchronization module (104) on the authentication server.

At the authentication point, the image capture module (109) in the camera-based decoder (108) captures the displayed pattern.

The pattern decoding module (110) decodes the captured pattern to extract the 24-bit payload, applying error correction via the error correction module (111).

The decoded payload is securely transmitted via the secure communication channel (113) to the pattern verification module (107) on the authentication server (105).

The pattern verification module (107) compares the decoded payload with the expected pattern generated using the shared secret key and current time interval or verifies the digital signature using the public key. If they match, authentication is granted.

Step-by-Step Process in various embodiments (Server-Assisted Pattern Generation):

The user device generates an encrypted time value using its private key and sends it to the server.

The server encrypts the received encrypted time value with its own private key.

The server generates an animated pattern based on the doubly-encrypted time value and sends it back to the user's device. The pattern is only displayed when an access request is initiated. The user device displays the animated pattern.

At the authentication point, the image capture module (109) in the camera-based decoder (108) captures the displayed pattern.

The pattern decoding module (110) decodes the captured pattern to extract the doubly-encrypted time value, applying error correction via the error correction module (111).

The decoded payload is securely transmitted via the secure communication channel (113) to the pattern verification module (107) on the authentication server (105).

The pattern verification module (107) decrypts the pattern using the server's private key, then decrypts the result using the user's public key to retrieve the original time value.

The original time value is compared with the current time. If it matches within an acceptable tolerance range, authentication is granted.

### Retail Applications

There are many retail applications for imperfect patterns, for example, as described in paragraph [0052] of the '013 application, a product may display an imperfect pattern to encode data, or as described in paragraph [0054] of the '013 application, a retailer may attach a tag displaying an imperfect pattern to a product, and use the tag to identify the product at a point-of-sale terminal. In paragraphs [0066]-[0068] of the '013 application we discussed using imperfect patterns on containers, such as shipping containers, and associating a record in a database with an identifier encoded into the imperfect patterns.

Each of these applications leverage functionalities of imperfect patterns. Let's examine some of these applications of imperfect patterns in more detail as well as how the aesthetics of the designs drive measurable outcomes in the retail domain.

The imperfect pattern serves as a multi-functional tool in retail applications, seamlessly combining functions of security, increased efficiency, and branding across a variety of applications. By embedding codes that are both aesthetically integrated and visually non-detracting, the patterns enable a number of functional goals.

As discussed in paragraphs [0003]-[0005] of the '013 application, a graphic design can create mood, brand recognition, and draw attention to a product, and ultimately the aesthetic impression the design makes may affect our consumer behaviour more than the literal information displayed on a product.

Let's take as an example a dress in the window of a store. The dress display shows the dress itself with a graphic pattern, a certain cut, as well as the name of the brand, a price, and features and benefits of the dress, such as its material, breathability, durability. When a person walks by the store, they may choose to stop and look at the dress, they may choose to enter the store, they may choose to try it on, all measurable and functional outcomes of the choice of dress. Most importantly, a consumer will engage in this situation if the dress makes a connection with them, expressing a value they have, an image of themselves they want to promote, or something they enjoy that they want to share such as puppies, their sports team, or an abstract image such a refined new-england aesthetic. An imperfect pattern may be used to make this personal connection and attract consumers whereas the information content is used by the consumer to filter the products.

Similarly a can of beans placed on a supermarket shelf displays a graphic pattern as well as informational content such as ingredients, nutritional information, where it originated and who distributes it. A price displayed below the can for price discrimination. As shown in multiple studies (cite them), consumer attention and attitude is driven by the aesthetic features of the can. It is less influential if the word “Fresh” is printed on the can than if a graphic design conveys the concept of freshness without words via choices in colors, design elements, and composition. Alternatively the graphic composition displayed on the can may attract consumers who want to try something specific like “BBQ style”, “Organic”, or “Hawaiian” beans. A product with product packaging that does not graphically convey the feature or benefit of the product that attracts its customers will not be able to successfully compete with a product that does.

Within retail environments, imperfect patterns may be used to support secure product and packaging authentication, including verification of individual products, shipping boxes, seals, or batches, thereby deterring counterfeiting and diversion. The same patterns may improve efficiency of item processing in stores, distribution centers, or manufacturing environments by enabling rapid, unobtrusive scanning of encoded items such as gift cards, coupons, loyalty materials, or promotional items.

Imperfect patterns may also enhance customer engagement by enabling interactive experiences. For example, a consumer may scan an imperfect pattern to verify the authenticity of a gift card, claim a rebate, enter a sweepstakes, access supplemental product information, or unlock personalized promotions. Because the data encoding is integrated into the product's visual design, these interactions may feel more natural and less intrusive than interactions based on conventional codes.

In addition, imperfect patterns may reinforce brand trust and recognition by incorporating logos, colors, motifs, or other familiar aesthetic elements into the data-encoding design. When applied consistently across products or packaging, such patterns may strengthen brand identity while maintaining the ability to convey verifiable machine-readable information. In this manner, imperfect patterns support retail applications in which functional performance and visual presentation are jointly optimized rather than traded off against one another.

### Sales Countertop

An alternate approach may be embodied in a “sales countertop” on which a number of goods may be placed. The countertop itself may be a visual display capable of producing color beneath (and surrounding) each item. For example, if a customer dumps their items on the countertop, regions of the countertop may change color to indicate the status of each item. For example, items that have been successfully scanned may be encircled with a green glow around the item-such items may be removed from the countertop and bagged. Other items, such as stacked items may be encircled on the countertop with a red glow indicating they have not been scanned. Such items may need to be moved, distributed, or flipped in order to be scanned. Such manipulation may be provided by the prompted customer, or by a mechanism of the counter such as a mechanical arm.

### Dual Function Apparel

Recall in paragraphs [0057], [0074]-[0075] of the '013 application that an imperfect pattern may be displayed on apparel, for example, to retrieve context sensitive information or associate ownership information with the apparel, and that training of the imperfect patterns may include the training image renderer described in paragraphs [0362]-[0369] of the '013 application which produces a decoder capable of extracting a data record from a arbitrarily curved surfaces and wherein only portions, or swatches, of the pattern are visible.

The ability to reliably and easily extract a data record from textiles and apparel is a valuable function that can be used for many applications. To revisit an earlier example, a designer may wish to produce a limited edition run of a line of apparel, each item having a different digital identity with slight variation in the graphics but with each item sharing a consistent predefined aesthetic.

The aesthetic may be designed 201 to increase marketability of an item, and may be chosen to target a specific demographic, or may be chosen based on appeal to a specific audience. The predefined aesthetic might also function to convey the brand image of the article, for example, to make the brand recognizable, or to differentiate the item from fake copies.

Such preferences, could be measured based on test marketing of the design displaying the imperfect pattern, and a designer optimizing the imperfect pattern, through a process such as process 200 of FIG. 2 of the present application can ensure that the additional function (e.g. branding, targeting a demographic, increasing marketability) is achieved through testing 206 and refinement 208 of the aesthetic of the imperfect pattern.

Testing 206 may comprise A/B tests, focus groups assigning a measurable metric to the functional goal, test marketing with measurement of function through direct measure of properties such as engagement or eye contact as measured in time, or interest as measured in clicks, purchases, or touching of an item, as well as metrics of incidence of scanning the imperfect pattern on the item. Recognition of brand identity could also be based on metrics of polling a target audience.

While we may, through some older methods of printing such as screen printing, produce a group of garments in which each item displays the same imperfect pattern, there are also many types of apparel manufacturing in which an imperfect pattern may be applied in a one-off method based on computerized printing or assembly methods. For instance, direct-to-garment printing can be used to print a unique imperfect pattern on each item. Transfer based (what's it called?) methods may apply an imperfect pattern to a textile, which may then subsequently be cut and sewn into a garment, or be applied as a patch on a garment. Automated embroidery machines may be used to of produce textiles which embody a data encoding imperfect pattern through the layering of threads, and a sequin machine can produce a garment with a unique sequin arrangement, wherein the sequins either moved or different color sequins, creating an image approximating a unique imperfect pattern may be applied to a garment to convey both sparkle and a unique data record.

Thus, using the techniques described herein, a plurality of garments may be manufactured, each displaying an imperfect pattern conveying the same predefined aesthetic designed for a measurable function outcome, and each garment also conveying a data record. The data record associated with each garment may be unique, or multiple garments may convey the same data record.

### Camouflage

Paragraphs and [0269]-[0276] of the '013 application describe imperfect patterns which are meant to hide an object by means of camouflage. For this dual-function example, we would identify 201 the aesthetic for the function of hiding an object in a certain operating environment (for example, woodland, desert, arctic, urban) and we might identify predefined criteria for the success or failure of the aesthetic function.

For example, we may cover articles with a potential camouflage design and create images of those articles on top of a standard set of background images. We could then test a number of human subjects or automated machine vision systems to measure the rate of detection of the object, or of the camouflage in the image amongst the human subjects of machine vision systems.

Armed with such a test, we can use it to guide the aesthetic for this function. Using the aesthetic we have identified, which may include the color palette, patches of pattern, characteristics of forms, or interaction of elements, we develop 203 a pattern template.

We also have a data function for the pattern, so need to size 202 the data that will be represented in the camouflage, for instance a serial number, a part number or a piece of equipment, or a service number, blood type, branch of service, religion of a soldier.

Using our pattern template, we generate 205 an encoder and decoder, and then test 206 the data encoding functionality and the object hiding functionality of the patterns, using our predefined testing criteria for such patterns. If the aesthetic of the generated patterns fail to achieve the predefined performance for this function (hiding objects), it may need to be refined 208 and a new pattern template will need to be developed 203 for testing. As with the previous example, this process iterates until a successful dual use design is complete 207.

### Imperfect Patterns to Improve Necessary UI Operations

A person interacting with a computer may do so as part of human-computer user interface for a computer application. The computer application, for example, may have a flow of steps that are required to complete an action such as checking out a customer, processing returned goods, applying a credit from a coupon, rebate or gift certificate, locating inventory, shipping goods, sorting an article, verifying authenticity of article. The human must perform certain steps of the flow required to complete the action, and user interface improvements which increase the speed and reliability with which an action can be performed add value to the computer application and system.

As imperfect patterns may be repeated or applied to broad areas of an article, a computer application requiring a person to scan the article with a camera can complete the task more quickly with an article displaying an imperfect pattern compared to an article displaying a conventional computer-readable code.

An imperfect pattern may improve reliability and speed of a person performing a task as part of a computer application by providing a recognizably unique user interaction. For example, a conventional login authenticator application may display a temporary code to enter into an application to support multi factor authentication as part of the process flow. An improvement of this process may be to have the authenticator application display a QR code to be scanned as part of the login flow, thus reducing the delay and risk of error in entering of the code.

Users of authenticator applications, however, typically have multiple systems that they access through such applications. If each system displays a QR code, then each code acts as a visual key to gain access to a particular website, cloud service, or application.

As part of a login process, a person performing the step should have confidence that they are presenting the correct key with as little time and effort as possible. An authenticator app as described above, but that instead provides a set of temporary keys expressed as imperfect patterns, provides the human using the application with an immediately recognizable pattern, differentiated from the other patterns used to gain access to alternate systems. The confidence and/or trust yielded by a fast visual interaction allows for an immediate detection of an incorrect key by the person and faster actions requiring less cognitive load, especially for repeated tasks.

### Combining Embodiments

The '013 application describes various embodiments, techniques, and methods that a person of ordinary skill in the art would understand may be used individually or in any combination. The material added in this continuation-in-part similarly introduces additional embodiments, methods, and techniques that are intended to be used individually or in combination with each other, as well as with any of the previously disclosed techniques or embodiments in the '013 application. Such combinations are contemplated within the scope of this disclosure, and the examples provided herein should not be considered limiting, but rather illustrative of the broad range of potential implementations.

In one embodiment, as described in paragraph [0439] of the '013 application, a machine-readable medium is provided. The machine-readable medium, including without limitation a non-transient machine-readable medium, having stored thereon data and instructions to cause a programmable processor to perform operations as described therein. In this continuation-in-part application, the machine-readable medium may further include instructions for additional processes, including but not limited to: generating imperfect patterns by transforming marks based on a data record and a pattern template, introducing controlled imperfections, and ensuring robustness to visual distortions or environmental conditions; decoding imperfect patterns by processing an acquired image of the pattern, analyzing transformations applied to the marks, extracting encoded data, and reconstructing the original data record; generating an encoder-decoder pair by training or configuring both components such that the encoder produces imperfect patterns based on input data records and the decoder reliably recovers the data records from the patterns; and selecting an appropriate decoder for a given imperfect pattern based on criteria such as the pattern template, transformation parameters, or environmental conditions. These instructions may also include operations to evaluate the robustness, accuracy, or fidelity of the encoding and decoding processes, ensuring reliable performance under a range of real-world conditions.

It should be understood that, while the present disclosure describes the training of separate functions or output of single machine learning models, such training may alternatively be implemented by dividing the described functions across one or more networks in an arbitrary manner. Additionally, functions described as being in separate machine learning models may be combined into a single model. The architecture and allocation of functions to networks are not limited to the embodiments explicitly described herein and may vary depending on the application or optimization requirements.

Furthermore, steps designated as being performed in batches, for computational efficiency or other reasons, could equivalently be performed sequentially or in other suitable configurations. These variations are intended to provide flexibility in implementation and should be considered within the spirit and scope of the subject matter described herein.

### Example Embodiments and Application Scenarios

The following examples describe non-limiting embodiments and use scenarios of the disclosed systems and techniques. These examples are provided for illustration and enablement only and are not intended to define, limit, or exhaust the scope of the invention or the appended claims. Features described in one example may be combined with features of other examples in any suitable manner.

In some example embodiments, a system is configured to augment an image to indicate which encoded imperfect patterns are being scanned, analyzed, or decoded. The system may include a scanning module configured to capture an image containing one or more imperfect patterns, a processing module configured to analyze the imperfect patterns and determine a decoding status or level of confidence, and a display configured to present an augmented image. Based on the decoding status, the system may overlay one or more visual indicators on the image, such as outlines, glows, bounding shapes, highlighting, changes in color or intensity, dimming of surrounding regions, graphical markers, or combinations thereof. The visual indicators may update dynamically as the scanning process proceeds.

In some examples, visual indicators are used to guide a user during scanning by indicating which objects or regions of an image are contributing to decoding or support determination. For example, visual indicators may change appearance to reflect scanning states such as pending, partially supported, successfully decoded, or error conditions. Indicators may also adapt based on alignment, distance, or orientation of a scanning device relative to an object, thereby guiding the user to reposition the device to improve decoding performance.

In other example embodiments, an image may contain multiple articles, each displaying an imperfect pattern encoding a different data record. The system may analyze the image to detect and decode multiple imperfect patterns within the same image, including cases where the patterns are visually similar, derived from the same or different common layouts, overlapping in space, or partially visible. In some examples, decoding may be performed without requiring prior segmentation of the image into individual objects or regions, while in other examples segmentation or region-based analysis may be applied. The system may operate under conditions of partial occlusion, physical deformation, noise, blur, or distortion, and may recover different payload sizes depending on image quality and pattern design.

In some embodiments, the system is configured to assist in ensuring that all relevant items within a scene have been scanned or accounted for. By identifying regions of an image that support encoded data records that have not yet been fully decoded, the system may flag unscanned or unresolved items. This capability may be used in environments such as warehouses, retail spaces, inspection areas, or checkout counters to reduce missed items or scanning errors.

In further examples, visual indicators are used to prioritize objects for scanning. Prioritization may be based on criteria such as proximity to the scanning device, likelihood of successful decoding, user preferences, scanning order, or application-specific requirements. Visual indicators may group multiple objects into categories for sequential or simultaneous scanning, and may adapt in real time to prevent scanning of incorrect or overlapping objects.

In some example embodiments, the system supports enhanced user interaction through augmented reality-style visualization. Visual indicators may provide real-time feedback on scanning accuracy, alignment, or completeness, and may include animations or interactive elements to illustrate optimal scanning angles or distances. Indicators may also signal errors or provide corrective guidance when scanning conditions are suboptimal. In certain examples, the augmented display dynamically marks scanned objects as completed and highlights remaining objects requiring attention.

In point-of-sale, countertop, or inventory environments, images captured over a surface may contain multiple items placed in proximity or temporarily obscured by hands or other objects. The system may use visual indicators to distinguish between items present, confirm correspondence between visually detected items and decoded data records, and identify discrepancies indicative of missed, hidden, or improperly scanned goods.

In some examples, the disclosed techniques are applied to articles comprising a surface featuring a plurality of graphic elements arranged within a visually apparent, tileable pattern unit. The graphic elements may encode a data record through variations in spatial arrangement, appearance, color contrast, or transformation from a defined layout. An encoded pattern may be deemed capable of encoding a data record if it meets a predefined decoding accuracy threshold under specified testing conditions. Decoding may be performed using trained machine learning models or other computational techniques, and may succeed even when portions of the pattern are missing or occluded.

Through these example embodiments and use scenarios, the disclosed systems enable robust scanning, decoding, user guidance, and interaction across a wide range of environments involving imperfect patterns, including situations where full decoding is not immediately possible or where multiple encoded objects are present within a single image.

### REFERENCES

The following publications are incorporated herein by reference in their entirety for all purposes:
P. V. M. Raju. Influence of Visual Merchandising on Customer's Purchase Decision. Gudlavalleru Engineering College, Academy of Marketing Studies Journal, Volume 26, Issue 1, 2022. Available at: https://www.abacademies.org/articles/Influence-of-visual-merchandising-on-customers-purchase-1528-2678-26-1-128.pdf
Yang Li, Jie Li. The Influence of Design Aesthetics on Consumers' Purchase Intention Toward Cultural and Creative Products: Evidence From the Palace Museum in China. Frontiers in Psychology, Volume 13, Jun. 30, 2022. DOI: 10.3389/fpsyg.2022.939403. Available at: https://www.frontiersin.org/journals/psychology/articles/10.3389/fpsyg.2022.939403/full
Dorotea Kovačević, Elma Mešić, Julia Užarević, Maja Brozović. The Influence of Packaging Visual Design on Consumer Food Product Choices. Journal of Print Media Technology Research, Volume 11, No. 1, 2022, pp. 7-18. DOI: 10.14622/JPMTR-2117. UDC: 366.1:621.798|72.012. Available at: https://jpmtr.org/jpmtr_11% 282022%291_web_2117.pdf
Zeiler, M. D., & Fergus, R. (2014). Visualizing and Understanding Convolutional Networks. In Computer Vision—ECCV 2014 (pp. 818-833). Springer. https://doi.org/10.1007/978-3-319-10590-1_53
Mnih, V., Heess, N., Graves, A., & Kavukcuoglu, K. (2014). Recurrent Models of Visual Attention. Advances in Neural Information Processing Systems, 27, 2204-2212.

Various embodiments of the present disclosure may fall within the scope set forth in any of examples 1-344 included in the provisional application of the present application, which is incorporated by reference herein. The inventors intend to claim all modifications and variations coming within the spirit and scope of the appended claims.

1. A set of articles, each article having a surface displaying a set of marks, wherein the same set of marks is displayed on each article in the set, with each mark visually identifiable by its shape, size, or other distinguishing measurable characteristic, the arrangement of the marks on each article differing from their arrangement on other articles in the set, with variations in at least one measurable property of the marks, including position, size, orientation, or spacing, the arrangement of the marks on each article forms a visually distinct pattern that conveys a digital payload comprising a plurality of binary data bits, the digital payload includes a subset of bits dedicated to error detection or correction, enabling the payload to be verified for accuracy, the arrangement of the marks across the set of articles forms a continuum of variations rather than a discrete set of arrangements, and no single mark is necessary for the decoding of the digital payload.

2. The set of articles of claim 1, wherein the marks comprise images of text or text characters.

3. The set of articles of claim 1, wherein the subset of bits dedicated to error detection and correction are compatible with a reed-solomon algorithm, and the verification for accuracy is performed by the reed-solomon algorithm.

4. The set of articles of claim 1, wherein the data can be yielded from the decoder when no more than an arbitrary half of the marks are visible in an image supplied to the decoder.

5. The set of articles of claim 1, wherein the marks are displayed on each article in the form a seamlessly repeating pattern unit, two adjacent instances of the pattern unit abutting on the surface of the object with the edge between the pattern units aligned, at least one mark conveying data positioned across the boundary of the repeating pattern such portions of mark are rendered on opposite sides of the boundary to form a complete and uninterrupted mark.

6. The set of articles of claim 1, wherein the same number of marks is displayed across the set, and the transformation of each mark is an ensemble of marks encoding a verifiable plural-bit data record, the ensemble observable on a visual medium, comprising: marks arranged in a seamless pattern on the visual medium;
wherein the data record is redundantly encoded within the ensemble, such that it can be computationally recovered by observation of a portion of the ensemble through analysis of the collective visual presentation of the marks; wherein the seamless pattern has no discernable boundaries or locating devices;
wherein no individual mark is required to retrieve the full data record; and
wherein the data record includes error detection or error correction bits to verify the validity of the data record.

7. The set of articles of claim 6, wherein the ensemble visually communicates a recognizable brand identity or predefined aesthetic emotional framing through traits such as the artwork, composition, stroke, and color, while maintaining seamless integration with data encoding functionality.

8. The set of articles of claim 6, wherein the visual medium comprises a physical substrate, such as paper, fabric, or plastic.

9. The set of articles of claim 6, wherein the visual medium comprises a digital image.

10. The set of articles of claim 6, wherein the data record can be computationally recovered from a portion of the ensemble when observed on a singly or doubly curved visual medium, or when the appearance of the ensemble on the visual medium is distorted by viewing angle or projection.

11. The set of articles of claim 6, wherein the (same) data record is independently computationally recovered from observation of complementary portions of the ensemble, the complementary portions having no marks in common.

12. The set of articles of claim 6, wherein the data record includes information that identifies or authenticates the visual medium.

13. The set of articles of claim 6, wherein the placement of at least one mark in the ensemble contributes to encoding the data record.

14. The set of articles of claim 6, wherein the curvature of at least one mark contributes to encoding the data record.

15. The set of articles of claim 6, wherein the seamless pattern includes marks crossing the boundaries between the repeating pattern unit, facilitating a consistent scanning performance across arbitrary comparable sized portions of the pattern.

16. The set of articles of claim 6, wherein at least one of the plurality of marks overlaps and partially covers another of the plurality of marks.

17. The set of articles of claim 6, wherein at least one of the marks is chosen from: a trademark, a curve, a continuous curve, full-color graphic element, a curved or distorted graphic element, a face, a three-dimensional graphic element.

18. The set of articles of claim 6, wherein the orientation of at least one mark relative to the ensemble contributes to encoding the data record.

19. The set of articles of claim 6, wherein the size of at least one mark contributes to encoding the data record.

20. A physical object of a set of physical objects, each physical object of the set of physical objects being associated with a data record and comprising at least one surface displaying a pattern of marks, the set characterized by:
a plurality of marks correlated across the set of physical objects;
the pattern of marks displayed on a physical object of the set comprising the plurality of marks;
at least one mark of the plurality of marks displayed across the set of physical objects in at least three distinct configurations, each distinct configuration being displayed on a different physical object of the set; and
wherein the configuration of the plurality of marks that form the pattern of marks on each physical object of the set is indicative of the associated data record, including cases in which the configuration encodes the associated data record.
